(19) United States
(12) Patent Application Publication
(10) Pub. No.: US 2015/0088952 A1
(43) Pub. Date: Mar. 26, 2015

(54) ARITHMETIC PROCESSING DEVICE

(71) Applicant: Sharp Kabushiki Kaisha, Osaka (JP)

(72) Inventors: Yoshimi II, Osaka-shi (JP); Akiyoshi SATOH, Osaka-shi (JP)

(73) Assignee: SHARP KABUSHIKI KAISHA, Osaka (JP)

(21) Appl. No.: 14/492,782

(22) Filed: Sep. 22, 2014

(30) Foreign Application Priority Data
Sep. 20, 2013 (JP) 2013-195385
Sep. 18, 2014 (JP) 2014-189522

(51) Int. Cl. G06F 17/11

(52) U.S. Cl. CPC G06F 17/11
USPC 708/490

(57) ABSTRACT

An arithmetic processing device includes: a reception unit for receiving information including a numerical value and an operator; a generation unit generating arithmetic information regarding an arithmetic operation and having a plurality of codes including the numerical value and the operator that are received; and an information transmission unit transmitting the generated arithmetic information to an external device. The generation unit generates the arithmetic information in which the codes are arranged so that, when a plurality of rows including numerical values and operators are displayed on a display unit of the external device in accordance with the arithmetic information, an arrangement of a numerical value and an operator in each displayed row and an arrangement of a numerical value and an operator in another displayed row are matched to each other.

This nonprovisional application is based on Japanese Patent Application No. 2013-195385 filed on Sep. 20, 2013 and No. 2014-189522 filed on Sep. 18, 2014, with the Japan Patent Office, the entire contents of which are hereby incorporated by reference.

### BACKGROUND OF THE INVENTION

1. Field of the Invention

The present invention relates to an arithmetic processing device, and particularly relates to an arithmetic processing device generating data-to-be-output in a predetermined format.

2. Description of the Background Art

A desktop-type calculator having a printer function (called printer calculator) prints calculation formulas and/or their results on a sheet of dedicated paper with ink. Some printer calculators print calculation formulas and/or their results on a sheet of dedicated paper with ink, and some printer calculators transfer calculation formulas and/or their results to spreadsheet software such as Excel® installed on a PC (abbreviation for personal computer) so that they can be displayed by the spreadsheet software. In this case, the PC recognizes the calculator as an HID (Human Interface Device).

PTD 1 (Japanese Patent Laying-Open No. 7-56667) discloses an electronic device which is an adapter connecting a computer and a keyboard to each other and has functions such as an arithmetic operation function comparable to a calculator, a display function, and a function of switching two modes, namely a calculator mode and a keyboard mode to each other.

PTD 2 (Japanese Patent Laying-Open No. 2005-346555) provides an electronic device which is a single device adaptable to each of the arithmetic schemes, namely the exact-order-of-operations scheme and the order-of-input scheme, and its arithmetic operation result based on a mathematical expression and an arithmetic operation result generated, based on the same mathematical expression, by an external device (which may be a PC) capable of communicating information have no inconsistency therebetween.

### SUMMARY OF THE INVENTION

According to PTD 1 and PTD 2, in the case where the calculator/electronic device and the computer are capable of communicating with each other, mathematical expression data such as arithmetic operation results obtained by the calculator/electronic device is transmitted to the computer, and the computer displays the received mathematical expression data. Generally, in the case where the computer displays the data received from an external device, the mode of display by the computer is not consistent with the mode of output by the device having transmitted the data. There has thus been a request by users to have a device excellent in convenience in that there is no inconsistency in terms of the mode of display.

The present disclosure has been made to solve the above problem and an object of the present disclosure is to provide an arithmetic processing device such as calculator excellent in convenience.

An arithmetic processing device according to an embodiment is an arithmetic processing device capable of communicating with an external device including a display unit, and including: a reception unit for receiving information including a numerical value and an operator; a generation unit generating arithmetic information regarding an arithmetic operation and having a plurality of codes including the numerical value and the operator received by the reception unit; and an information transmission unit transmitting the generated arithmetic information to the external device. The generation unit is configured to generate the arithmetic information in which the codes are arranged so that, when a plurality of rows including numerical values and operators are displayed on the display unit of the external device in accordance with the arithmetic information, an arrangement of a numerical value and an operator in each displayed row and an arrangement of a numerical value and an operator in another displayed row are matched to each other.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view of a system according to a first embodiment.

FIG. 2 is a hardware configuration diagram of a calculator according to the first embodiment.

FIG. 3 is a hardware configuration diagram of a PC according to the first embodiment.

FIG. 4 is a diagram showing a functional configuration of the calculator according to the first embodiment.

FIG. 5 is a diagram showing a functional configuration of the PC according to the first embodiment.

FIG. 6 is a diagram showing an example of printing/display according to the first. embodiment.

FIG. 7 is a diagram showing control-codes-mixed information according to the first embodiment.

FIG. 8 is a diagram showing an example of display by a table generator according to the first embodiment.

FIG. 9 is a diagram showing generation of the control-codes-mixed information according to the first embodiment, using a plurality of sets.

FIG. 10 is a diagram showing generation of the control-codes-mixed information according to the first embodiment, using a plurality of sets.

FIG. 11 is a diagram showing generation of the control-codes-mixed information according to the first embodiment, using a plurality of sets.

FIG. 12 is a process flowchart according to the first embodiment.

FIG. 13 is a process flowchart according to the first embodiment.

FIG. 14 is a diagram showing control-codes-mixed information according to a second embodiment.

FIG. 15 is a diagram showing generation of the control-codes-mixed information according to the second embodiment, using a plurality of sets.

FIG. 16 is a diagram showing generation of the control-codes-mixed information according to the second embodiment, using a plurality of sets.

FIG. 17 is a diagram showing generation of the control-codes-mixed information according to the second embodiment, using a plurality of sets.

FIG. 18 is a diagram showing an example of printing of information according to a third embodiment.

FIG. 19 is a diagram showing an example of display of information according to the third embodiment.

FIG. 20 is a diagram showing generation of control-codes-mixed information according to the third embodiment, using a plurality of sets.

FIG. 21 is a diagram showing generation of control-codes-mixed information according to the third embodiment, using a plurality of sets.

FIG. 22 is a diagram showing generation of control-codes-mixed information according to the third embodiment, using a plurality of sets.

FIG. 23 is a process flowchart according to the third embodiment.

FIG. 24 is a process flowchart according to the third embodiment.

FIG. 25 is a process flowchart according to the third embodiment.

FIG. 26 is a diagram showing an example of display of information according to the a fourth embodiment.

FIG. 27 is a diagram showing generation of control-codes-mixed information according to the fourth embodiment, using a plurality of sets.

FIG. 28 is a diagram showing generation of control-codes-mixed information according to the fourth embodiment, using a plurality of sets.

FIG. 29 is a diagram showing generation of control-codes-mixed information according to the fourth embodiment, using a plurality of sets.

FIG. 30 is a process flowchart according to the fourth embodiment.

FIG. 31 is a process flowchart according to the fourth embodiment.

FIG. 32 is a diagram showing generation of control-codes-mixed information according to a fifth embodiment, using a plurality of sets.

FIG. 33 is a diagram showing generation of control-codes-mixed information according to the fifth embodiment, using a plurality of sets.

FIG. 34 is a diagram showing generation of control-codes-mixed information according to the fifth embodiment, using a plurality of sets.

FIG. 35 is a diagram showing generation of control-codes-mixed information according to the fifth embodiment, using a plurality of sets.

FIG. 36 is a process flowchart according to the fifth embodiment.

FIG. 37 is a process flowchart according to the fifth embodiment.

### DESCRIPTION OF THE PREFERRED EMBODIMENTS

In the following, embodiments will be described in detail with reference to the drawings. The same elements are denoted by the same reference characters in the drawings, and a detailed description thereof will not be repeated.

In the embodiments, “character” includes numerical value, kana, kanji, and symbol (including operator). “Mathematical expression” refers to a character string in which characters (such as numerical values, operators, and characters representing indeterminates) are arranged according to a certain rule. “Arithmetic expression” refers to an expression for an arithmetic operation that is expressed by means of a mathematical expression.

“Control code” refers to a code for controlling an operation of outputting (displaying, printing) information. This code includes a code for variably controlling the display position of a cursor which indicates the position where a character is output in an information output region of a display.

While the character or control code is herein supposed to be expressed by a character code such as ASCII code for example, how to express it is not limited to this. In the embodiments, the character code or control code is also referred to as code.

### First Embodiment

### Device Configuration

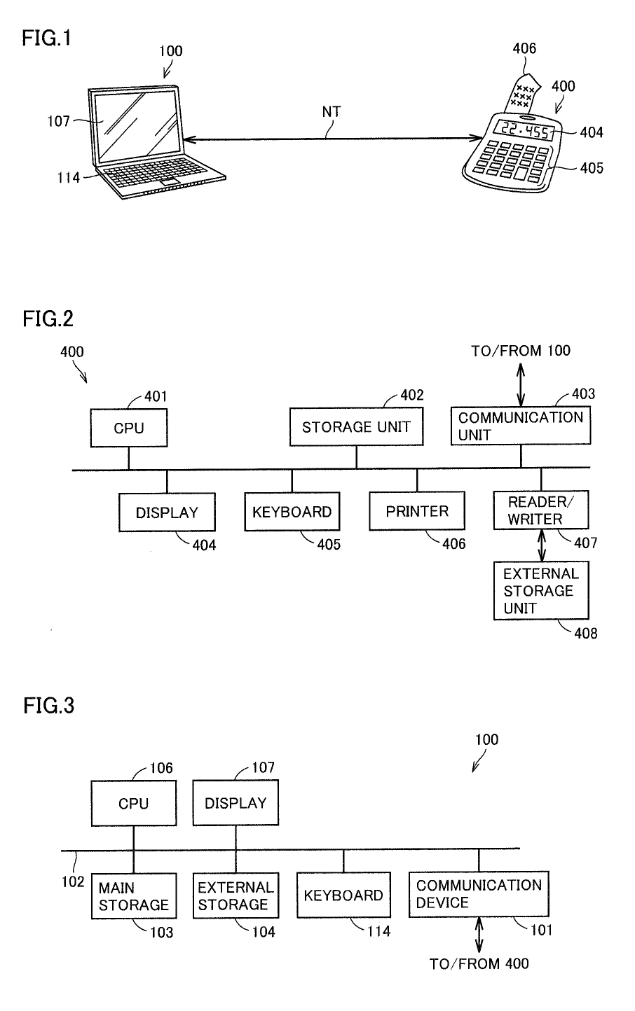

Referring to FIG. 1, a system according to the embodiments includes a PC (abbreviation for personal computer) 100 corresponding to an external device, and a calculator (electronic desktop calculator) 400 corresponding to an arithmetic processing device. The PC and the calculator perform wireless or wired communication therebetween through a communication line NT in accordance with the USB (Universal Serial Bus) or Bluetooth® or the like. FIG. 2 shows a hardware configuration of calculator 400, and FIG. 3 shows a hardware configuration of PC 100.

Referring to FIG. 2, calculator 400 includes a CPU (Central Processing Unit) 401, a storage unit 402 including volatile and nonvolatile memories such as RAM (Random Access Memory) and ROM (Read Only Memory), a communication unit 403 including modem and the like, a display 404, a keyboard 405, a printer 406, and a reader/writer 407 that are connected to each other through an internal bus. Storage unit 402 may include a hard disk.

Communication unit 403 encodes communication data from CPU 401 to convert it into a communication signal, and transmits the communication signal to PC 100. It also decodes a signal received from PC 100 to convert it into communication data, and outputs the communication data to CPU 401. When communication unit 403 performs wireless communication, it communicates through an antenna (not shown) with PC 100. Communication unit 403 is also capable of communicating with an external device including PC 100 through a network (not shown). Communication unit 403 may also be provided as a wireless device detachably attached to calculator 400.

Display 404 such as liquid crystal display displays a character string and an image for example based on display control data from CPU 401. Based on print control data from CPU 401, printer 406 prints a character string and an image for example on a sheet of paper.

Keyboard 405 includes a variety of keys such as ten key operated by a user for entering numerical values, characters, symbols and the like or entering a variety of commands such as commands to print, transmit, and the like.

To reader/writer 407, an external storage unit 408 including card-shaped storage medium or the like is externally and detachably attached. CPU 401 reads and writes data or program from and to the attached external storage unit 408. The data or program read from external storage unit 408 is stored in a predetermined storage area of storage unit 402.

Referring to FIG. 3, PC 100 includes a CPU (Central Processing Unit) 106, a main storage unit 103 including volatile and nonvolatile memories such as RAM (Random Access Memory) and ROM (Read Only Memory), an external storage unit 104, a communication device 101 including modem and the like, a display 107, and a keyboard 114 that are connected to each other through an internal bus. PC 100 may include a printer. To external storage unit 104, a storage medium is externally and detachably attached, and external storage unit 104 reads and writes data and program from and to the attached storage medium.

Communication device 101 encodes communication data from CPU 106 to convert it into a communication signal, and transmits the communication signal to calculator 400. Communication device 101 also decodes a signal received from calculator 400 to convert it into communication data, and outputs the communication data to CPU 106. In the case where communication device 101 performs wireless communication, it communicates with calculator 400 through an antenna (not shown). Communication device 101 is also capable of communicating with an external device including calculator 400 through a network (not shown). Communication device 101 may also be provided as a wireless device detachably attached to PC 100.

Display 107 such as liquid crystal display displays a character string and an image for example based on display control data from CPU 106. Based on print control data from CPU 106, a printer (not shown) prints a character string and an image for example on a sheet of paper.

Keyboard 114 includes a variety of keys such as ten key operated by a user for entering numerical values, characters, symbols and the like or entering a variety of commands such as commands to print, transmit, and the like.

In the present embodiment, calculator 400 has a function of communicating with PC 100 through communication unit 403. Receiving a request to communicate from calculator 400 when communication is to be started, PC 100 recognizes, from what is received from calculator 400, that calculator 400, namely HID (Human Interface Device), has been connected. While calculator 400 has a function serving as a printer calculator, printer 406 may be detachably attached to calculator 400.

### Functional Configuration

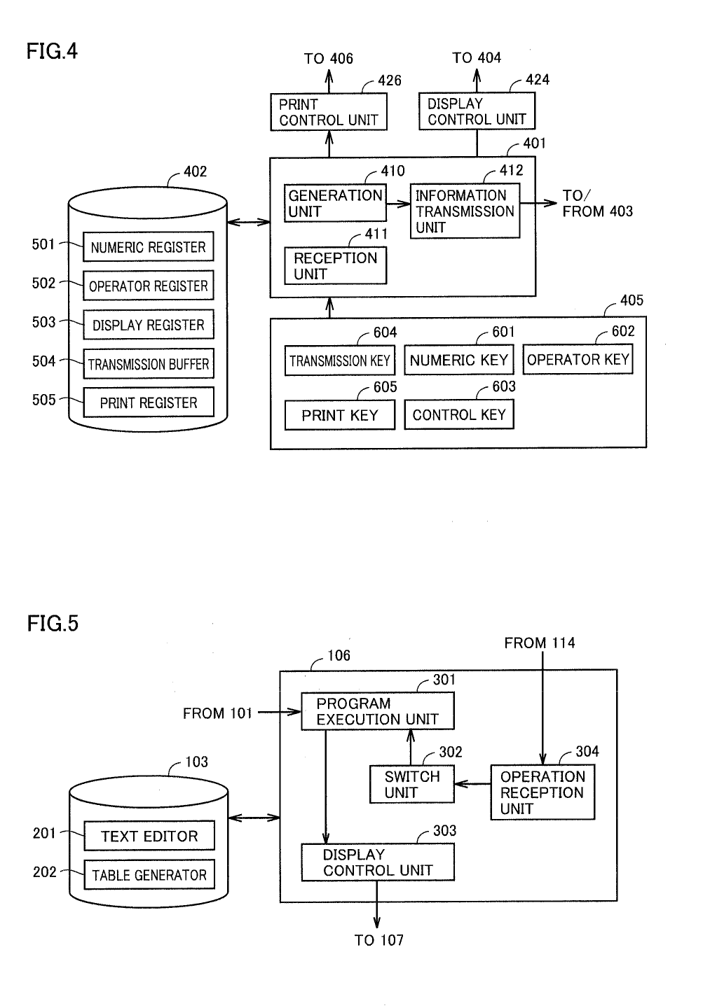

FIG. 4 shows a functional configuration of calculator 400, and FIG. 5 shows a functional configuration of PC 100. Referring to FIG. 4, calculator 400 includes a generation unit 410, a reception unit 411, and an information transmission unit 412 that are functions of CPU 401. Reception unit 411 operates to obtain information (more specifically character codes) including numerical values, operators, and the like from key codes of keys operated by a user through keyboard 405 and thereby receive this information. Generation unit 410 generates control-codes-mixed information, according to a predetermined rule, from numerical values and operators received by reception unit 411 and a control code or the like for controlling an operation of displaying information by an external device. Information transmission unit 412 transmits the control-codes-mixed information to PC 100 which is an external device. The control-codes-mixed information herein refers to arithmetic information regarding an arithmetic operation and including the result (including the intermediate result) of the arithmetic operation.

Storage unit 402 has a storage area used for generating, displaying, and printing the control-codes-mixed information. In this storage area, a numeric register 501, an operator register 502, a display register 503, a transmission buffer 504, and a print register 505 are set.

In a predetermined area of storage unit 402, control codes and character codes are stored. When generation unit 410 is to generate control-codes-mixed information, it reads a control code or character code from storage unit 402. Based on a key code of a key operated by a user, generation unit 410 searches storage unit 402 to read a corresponding character code.

Numeric register 501 stores a character code of a numerical value entered through a key. Operator register 502 stores a character code of an operator entered through a key. Display register 503 stores character codes of numerical values and the like to be displayed on display 404 of calculator 400. Each time the contents of display register 503 are updated, CPU 401 reads information of display register 503. The read information is displayed through a display control unit 424 on display 404. Transmission buffer 504 stores information (such as character codes, control codes, and the like) to be transmitted from calculator 400 to PC 100. Print register 505 stores information to be transmitted to a print control unit 426 (described later herein).

To CPU 401, display control unit 424 and print control unit 426 are connected. Based on display control data of CPU 401, display control unit 424 generates a signal (voltage signal or current signal) which drives display 404, and outputs information to display 404 based on the generated signal. On display 404, information (such as characters and images) based on the display control data is displayed. Print control unit 426 generates a drive signal (voltage signal or current signal) of printer 406 based on print control data which is generated from information of print register 505 by CPU 401, and outputs the generated signal to printer 406. Printer 406 prints, on a sheet of paper, information (such as characters and images) based on the print control data.

Keyboard 405 connected to CPU 401 includes a numeric key 601 operated for entering a numerical value, an operator key 602 operated for entering an operator (such as +, −, ×, ÷, =, *), a control key 603 operated for entering a control code, a transmission key 604 operated for giving an instruction to transmit, and a print key 605 operated for giving an instruction to print by printer 406.

Referring to FIG. 5, CPU 106 of PC 100 includes a program execution unit 301 for executing a program, an operation reception unit 304 receiving operation details from an operation unit such as keyboard 114 and outputting a command in accordance with the received operation details, a switch unit 302 outputting to program execution unit 301 a switch command when the switch command for a program is input from operation reception unit 304, and a display control unit 303 controlling display by display 107 based on display control data from program execution unit 301.

In main storage unit 103, a variety of programs are stored including a text editor 201 for generating text (document) data from character codes and outputting it in a text format, and a table generator 202 for generating a table in accordance with character codes and outputting it in a table format. Text editor 201 is also called by a program name “memo pad” herein and table generator 202 is also called by a program name “Excel®” herein. For the sake of simplification of description, program execution unit 301 reads and executes a program of one of text editor 201 and table generator 202 of main storage unit 103, in accordance with a switch command from switch unit 302. In the case where multitasking execution of programs by means of the multi-window function or the like is possible, program execution unit 301 executes one of text editor 201 and table generator 202 in the foreground and executes the other in the background in accordance with a switch command from switch unit 302. The program which is being executed by program execution unit 301 is also referred to as running program.

### Overview of Process Procedure

In the present embodiment, calculator 400 prints, by means of printer 406, information entered through user's operation of keys of keyboard 405, and also transmits the information to PC 100. Receiving the information from the HID (calculator 400), PC 100 processes the received information and displays it on display 107. Thus, calculator 400 communicating with PC 100 can also operate as an external keyboard of PC 100.

A description will be given of a case where the contents corresponding to what is printed by printer 406 are to be displayed on display 107 of PC 100. More specifically, in a case where numerical values and operators printed by printer 406 are to be displayed on display 107, an arrangement of the numerical values and the operators to be printed and an arrangement of them to be displayed on display 107 are matched to each other by a process as described below.

“Matching” herein refers to adjustment, in the case where a plurality of rows including numerical values and operators are to be displayed (or printed), of an arrangement of a numerical value and an operator in each row and an arrangement of a numerical value and an operator in another row, with respect to each other. For example, this includes but not limited to equalizing respective numbers of digits in numeric strings (strings each made up of one or more numerical values) to be displayed in respective rows, and making respective decimal-point digit positions in respective rows identical to each other, and aligning respective positions where operators are output, or respective positions of the beginnings or ends of numeric strings in respective rows, with respect to each other, for example.

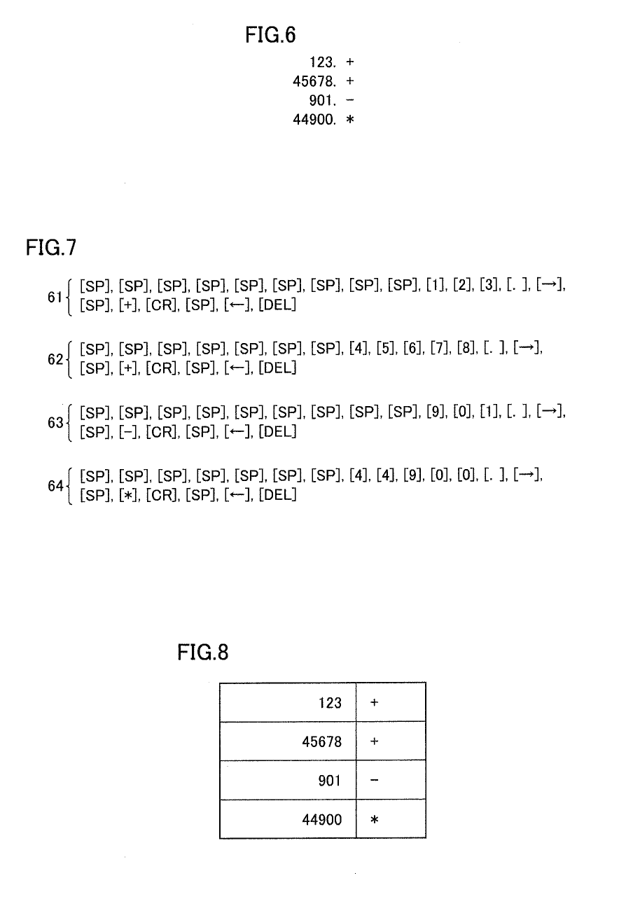

In the case for example where a user operates keys of keyboard 405 to input (123[+=]45678[+=]901[−=] [*]) which intends calculation of (123.+45678.−901.) and CPU 401 processes the arithmetic expression based on the key operation details to provide the result 44900 of this calculation, an arrangement of numerical values and operators in two columns×N (N=1, 2, 3, . . . ) rows as shown in FIG. 6 is displayed and printed. Specifically, the left column is a column where numerical values are displayed/printed (displayed and printed), and the right column is a column where operators are displayed/printed. Details will be described with reference to FIGS. 7 and 8. Information 61 to information 64 in FIG. 7 each represent control-codes-mixed information generated by generation unit 410. Specifically, generation unit 410 generates the control-codes-mixed information, following a predetermined rule, from numerical values and operators in FIG. 6 and control codes for controlling the operation of displaying information by the display unit (display 107). FIG. 8 shows an example of display produced by table generator 202 based on information 61 to information 64 in FIG. 7.

First, it is supposed that character codes in FIG. 6 are stored in storage unit 402. In the case where the data of the first row is to be transmitted to PC 100, generation unit 410 generates information 61 in FIG. 7, and the generated information is transmitted through information transmission unit 412 to PC 100. Specifically, when codes of numerical values are to be transmitted, space code(s) [SP] which is a control code for equalizing the number of digits is placed before the numerical values and then the information is transmitted through information transmission unit 412. For example, in the case where printer 406 prints 12 digits, nine space codes [SP] are arranged before the numerical values “123.” in the first row. These spaces are provided for right justification of the information to be displayed by text editor 201. The program of table generator 202 ignores the space codes [SP].

Then, before the operator (+) following the numerical values is transmitted, a control code [→] of cursor-key movement is transmitted through information transmission unit 412 so that this control code is placed for moving a cursor to a position to the right of the character string. Instead of the control code [→], a tab code [TAB] which is a control code effecting a similar function for table generator 202 (a control code for moving a cursor to a right cell of the table) may be used. In the case where the tab code [TAB] is used, text editor 201 displays the numerical values and the operator so that the numerical values and the operator are spaced out.

Subsequently, a newline control code [CR] is transmitted after the code for the operator (+) is transmitted, so that a new row is started after the operator (+). The control code [CR] is a control code for moving the cursor to the next row.

Next, one space code [SP] and a control code [←] of cursor-key movement for moving the cursor to a position to the left of a character string are transmitted through information transmission unit 412. They are control codes necessary for positioning the cursor at the beginning of the next row by proceeding to the next row. If the space code [SP] is not arranged, text editor 201 causes the cursor to return to the preceding row by the control code [←]. In order to prevent this, the newline control code [CR] and the subsequent space code [SP] and control code [←] arranged side by side are transmitted.

Next, a DELETE control code [DEL] is generated and transmitted to PC 100 so that this control code is placed. The control code [DEL] enables a space displayed by text editor 201 to be deleted. In this way, generation of control-codes-mixed information 61 in FIG. 7 and transmission of this control-codes-mixed information to PC 100 are completed.

Subsequently, for the second row and its following rows in FIG. 6, generation unit 410 similarly generates control-codes-mixed information 62 to 64. The generated control-codes-mixed information is transmitted by information transmission unit 412 to PC 100.

In the case where PC 100 receives control-codes-mixed information 61 to 64 in FIG. 7 and the running program is text editor 201, text editor 201 displays the numerical values and operators on display 107 while moving the cursor in accordance with the received control-codes-mixed information 61 to 64. Accordingly, display 107 indicates the mathematical expression in the document format like FIG. 6. When the running program is table generator 202, table generator 202 displays the numerical values and operators in the table format like FIG. 8 in accordance with the received control-codes-mixed information 61 to 64.

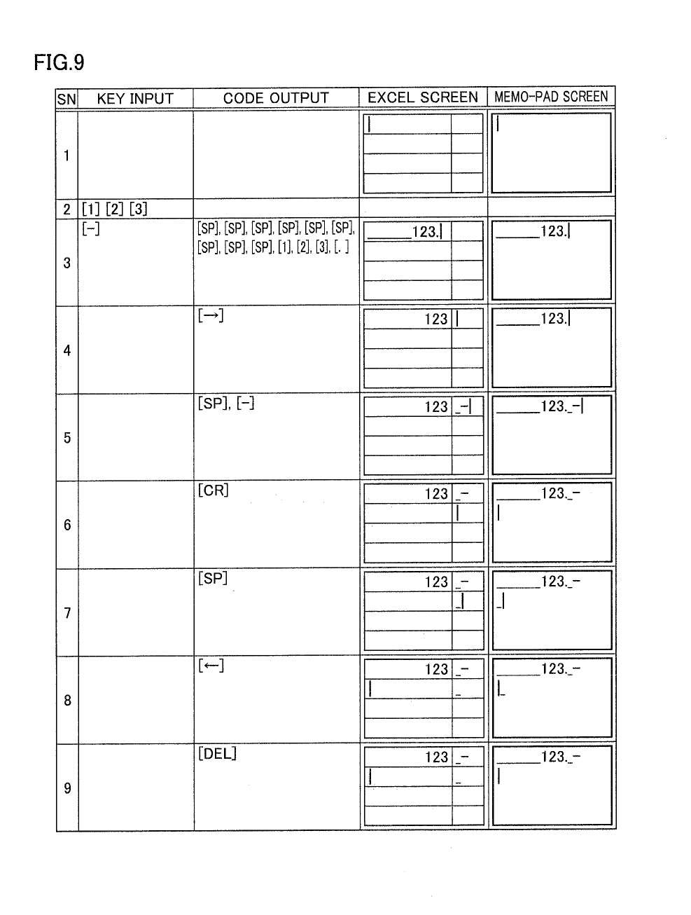

FIGS. 9 to 11 show, using a plurality of sets, interrelations of information in the case where control-codes-mixed information is generated. Each set includes an identification number SN, a key input indicating key(s) operated by a user, a code output indicating an arrangement of codes generated by generation unit 410 in accordance with the key input, and an Excel screen and a memo-pad screen which are example screens displayed on display 107 in accordance with the code output. The Excel screen is an example screen displayed by table generator 202, and the memo-pad screen is an example screen displayed by text editor 201. These sets are herein identified by identification numbers SN1 to SN24, respectively. “|” displayed on the Excel screens or memo-pad screens in the sets of FIGS. 9 to 11 represents a cursor, and “_” displayed thereon represents a space. This is applied as well to the sets illustrated in the following embodiments.

In the case where a code output of the first row in FIG. 6 is to be provided in the condition where no key has been operated for input (see set SN1 in FIG. 9), keys are operated to input the numerical values “123” (see set SN2). Subsequently, a key is operated to input the operator “−” which causes generation unit 410 to generate a code string in which numerical values [1], [2], and [3] and a decimal point [.] are arranged (see set SN3). In the case where generation unit 410 is to generate a code string of numerical values, generation unit 410 arranges space codes [SP] for equalizing the number of digits, before the numerical-value code string. For example, in the case where printer 406 prints 12 digits, nine space codes [SP] are arranged before the numerical values “123.” of the first row. These spaces are provided for right-justifying the numerical values (see the memo-pad screen of set SN3) in the case where they are displayed by text editor 201. The space codes [SP] are ignored in the program of table generator 202 (see the Excel screen of set SN3).

Then, in response to operation of the key to input the operator (−) following the numerical values “123”, a code output of the numerical values of set SN3 is transmitted.

Before the operator (−) is transmitted, generation unit 410 provides the code outputs (see sets SN4 and SN5) so that the control code [→] for moving the cursor to the position to the right of the character string and the space code [SP] are arranged side by side. Instead of the control code [→], the tab code [TAB] effecting a similar function for table generator 202 (the control code moving the cursor to the cell to the right in a table) may be used. In the case where the tab code [TAB] is used, text editor 201 displays the numerical values and the operator so that there is a space therebetween. The space code [SP] located before the operator (−) is set for defining a distance (space) between the numerical values and the operator. Therefore, as long as the visibility of the display is not lost, two or more space codes [SP] may be set or no space code may be set.

Subsequently, after the code of the operator (−) is transmitted, generation unit 410 outputs the control code [CR] so that a new row is started after the operator (−) (see set SN6). The newline control code [CR] is a control code for moving the cursor to the next row.

In the case where generation unit 410 outputs the control code [CR], it generates and outputs one space code [SP] and a control code [←] so that these are arranged side by side (see sets SN7 and SN8). These control codes are control codes necessary for positioning the cursor at the beginning of the next row by the control code [CR]. If the space code [SP] is not arranged, text editor 201 causes the cursor to return to the preceding row by the control code [←]. Thus, subsequent to the newline control code [CR], the space code [SP] and the control code [←] are output so that they are arranged side by side.

Next, generation unit 410 outputs the control code [DEL] so that the code is arranged (see set SN9). The control code [DEL] enables a space left in the memo-pad screen given by text editor 201 to be deleted. In this way, generation unit 410 generates the control-codes-mixed information which is a code string in which the codes of the numerical values and operator and the control codes are mixed. The generated control-codes-mixed information is transmitted to PC 100. In PC 100, the running program analyzes the codes from the beginning code of the code string (in the order in which the codes are received) included in the received control-codes-mixed information and performs, based on the results of analysis, a display process while controlling the cursor position (see set SN9).

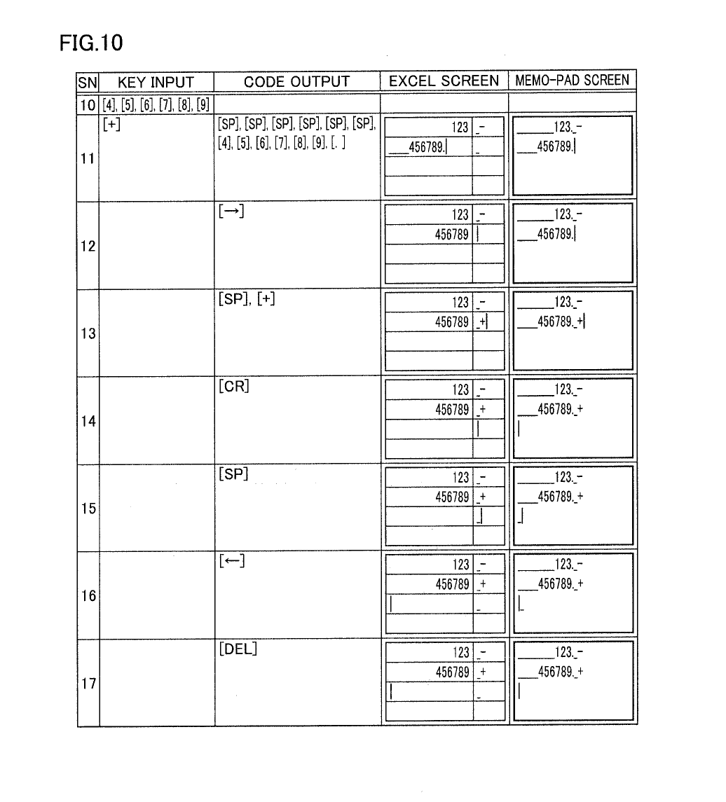

Subsequently, a description will be given of the case where control-codes-mixed information of “456789.” and “+” of the second row is to be transmitted. As shown in sets SN10 to SN17 in FIG. 10, the control-codes-mixed information is generated similarly to sets SN2 to SN9, and the generated control-codes-mixed information is transmitted to PC 100. Based on the received control-codes-mixed information, PC 100 performs a display process (see set SN17).

Finally, in response to user's operation of a key of a total operator “*” CPU 401 performs a calculation based on what have been input (numerical values and operators for example), in accordance with the arithmetic expression “456789−123” and outputs “456666” which is the result of the operation.

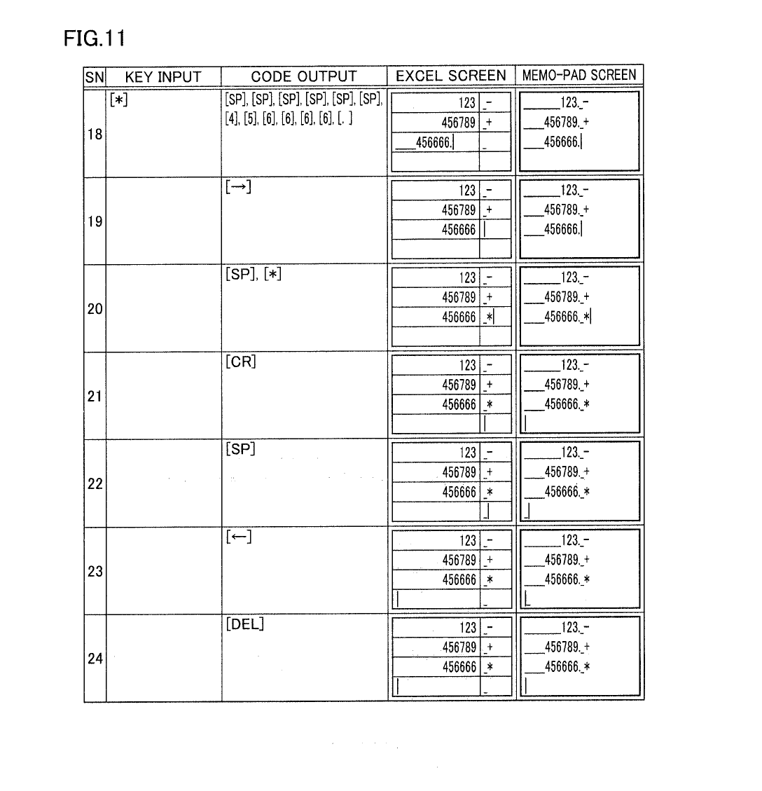

After this, in the case where control-codes-mixed information of “456666.” and “*” in the third row is to be transmitted, generation unit 410 generates the control-codes-mixed information as shown in sets SN18 to SN24 in FIG. 11, similarly to sets SN2 to SN9, and the generated control-codes-mixed information is transmitted to PC 100. Based on the received control-codes-mixed information, PC 100 performs a display process (see set SN24).

In this way, the arrangement of the numerical values and operator in each row on the Excel screen and the arrangement of the numerical values and operator in the same row on the memo-pad screen that are matched to each other can be displayed (see sets SN9, SN17, SN24).

### Process Flow

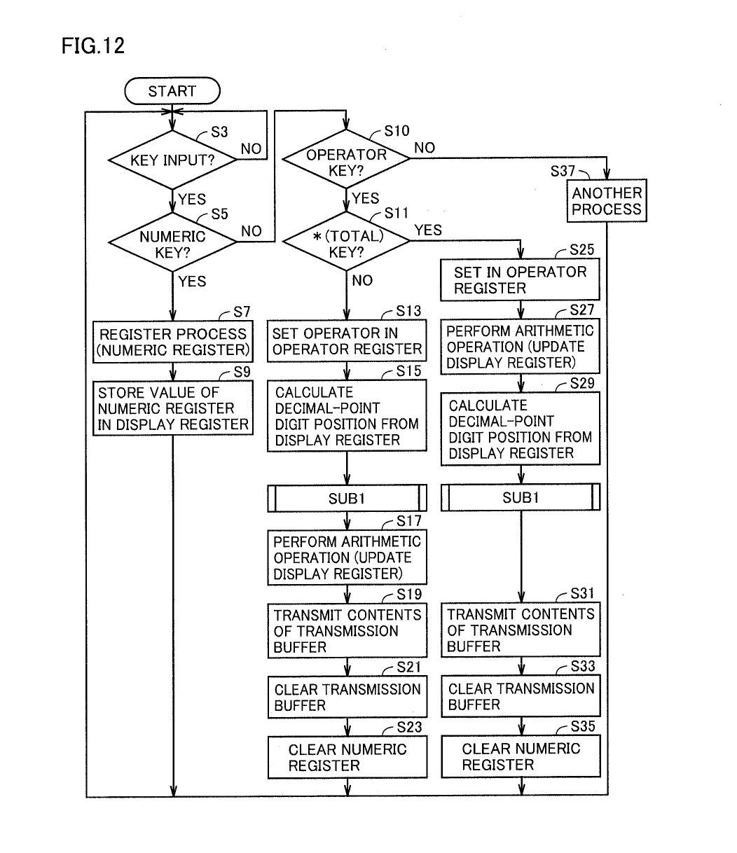

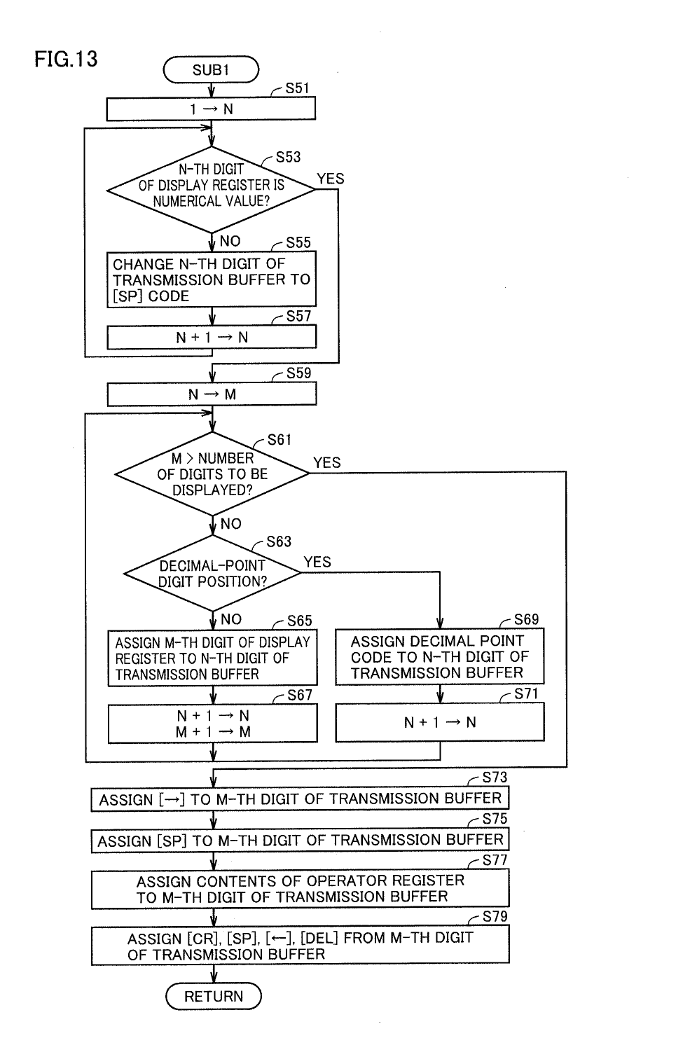

Referring to the flow charts of FIGS. 12 and 13, generation of the control-codes-mixed information in FIG. 7 and transmission of the control-codes-mixed information to PC 100 will be described. These flowcharts have been stored as programs in storage unit 402 in advance, and read from storage unit 402 and executed by CPU 401. A variety of registers and buffers used here have been cleared (initialized) in advance.

First, based on an output from keyboard 405, reception unit 411 determines whether or not a user has operated a key for input (step S3). As long as it is determined that a user has not operated a key for input (NO in step S3), the process of step S3 is repeated.

When it is determined that a key has been operated for input (YES in step S3), reception unit 411 provides to generation unit 410 a key code of the operated key.

Based on the provided key code, generation unit 410 determines whether or not the operated key is a numeric key (step S5). When it is determined generation that the operated key is a numeric key (YES in step S5), generation unit 410 performs a register process (step S7). In the register process, a character code represented by the key code of the numeric key is stored in numeric register 501.

After this, generation unit 410 reads the character code from numeric register 501 and stores the read character code in display register 503 (step S9). After this, the process flow proceeds to step S3.

In step S5 again, when it is determined that the operated key is not a numeric key (NO in step S5), generation unit 410 determines whether or not the operated key is operator key 602 (step S10). When it is determined that the operated key is operator key 602 (YES in step S10), it determines, from the key code, whether or not the operator key is the total key (“*”) (step S11). When generation unit 410 determines that the operator key is not the “*” key (NO in step S11), generation unit 410 stores a character code represented by the key code of the operator key in operator register 502 (step S13). Then, from a character code string of numerical values indicated by the contents stored in display register 503, a decimal-point digit position is calculated (step S15). For example, the position of the end of a numerical-value string is calculated, and the calculated position is identified as the decimal-point digit position.

Subsequently, from the contents stored in display register 503, generation unit 410 generates control-codes-mixed information and stores the generated control-codes-mixed information in transmission buffer 504. This process is referred to as “Process SUB1.” Process SUB1 will be described later herein with reference to FIG. 13.

After this, CPU 401 uses an arithmetic function to perform an arithmetic process in accordance with an arithmetic expression indicated by the contents of numeric register 501 and operator register 502, and stores in display register 503 a character code string representing the result (numerical value(s)) of the calculation (step S17). Thus, the character code string in display register 503 is updated by storage of the character code string representing the result of the arithmetic operation using numerical values and operators which have been input through keys.

After this, CPU 401 reads the control-codes-mixed information from transmission buffer 504 and transmits it through information transmission unit 412 to PC 100. CPU 401 thereafter clears the contents of transmission buffer 504 (step S21) and clears numeric register 501 (step S23). After this, the process flow proceeds to step S3.

In step S11 again, when generation unit 410 determines that the input operator key is “*” (YES in step S11), generation unit 410 stores in operator register 502 the character code represented by the key code of the input operator (step S25). CPU 401 thereafter uses the arithmetic function to perform an arithmetic operation in accordance with an arithmetic expression indicated by a character code string of numerical values in numeric register 501 and the operator in operator register 502. Then, it stores in display register 503 a character code representing a value of the result of the arithmetic operation. Accordingly, the contents of display register 503 are updated (step S27). After this, from the contents of display register 503, a decimal-point digit position is calculated as described above (step S29). After this, Process SUB1 is performed.

In Process SUB1, generation unit 410 updates the control-codes-mixed information in transmission buffer 504. The updated control-codes-mixed information is transmitted through information transmission unit 412 to PC 100 (step S31). Generation unit 410 thereafter clears transmission buffer 504 and clears numeric register 501 (steps S33, S35). After this, the process flow returns to step S3. What is done in steps S31 to S35 is similar to what is done in step S19 to S23 as described above.

In step S10 again, when it is determined that the key operated by the user is not an operator key (NO in step S10), CPU 401 performs another process in accordance with a command represented by the key code of the operated key (step S37). After this, the process flow returns to step S3.

### Process SUB1

Referring to FIG. 13, Process SUB1 will be described. In Process SUB1, variables M and N which are temporary variables for controlling the process are used. Variables M and N each represent a predetermined storage area of storage unit 402. Variable N is a variable to which the count value of the number of digits (number of characters) of a character code string stored in display register 503 is set (the count value is stored in the associated storage area). Variable M is a variable to which the count value of the number of digits (number of characters) to be displayed is set (the count value is stored in the associated storage area).

First, generation unit 410 sets initial value 1 to variable N (step S51). Subsequently, generation unit 410 determines, based on the contents of display register 503, whether or not the character of the N-th digit, namely the N-th character code, is a character code of a numerical value (step S53). When it is determined that it is not a character code of a numerical value (NO in step S53), generation unit 410 changes (rewrites) the N-th character from the beginning of transmission buffer 504, namely the character of the N-th digit from the beginning, to a space code [SP] (step S55). After this, the value of variable N is incremented by one (step S57), and the process flow returns to step S53. The process of steps S53 to S57 is repeated and accordingly one or more space codes [SP] are stored from the beginning of transmission buffer 504, for adjusting the character code string of numerical values in display register 503 to the aforementioned 12 digits.

When it is determined that the N-th digit of display register 503 is a character code of a numerical value (YES in S53), generation unit 410 sets the value of variable N to variable M (step S59).

Generation unit 410 determines whether or not a conditional expression (M>the number of digits to be displayed) is met (step S61). In the present embodiment, the number of digits to be displayed in this conditional expression is 12 digits.

When generation unit 410 determines that the condition is met (YES in step S61), the process flow proceeds to the process in step S73 described later herein. When it is determined that the condition is not met (NO in step S61), generation unit 410 determines whether or not the value of variable M represents the decimal-point digit position (the number of digits calculated in step S15 or S29) (step S63). When it is determined that the value of variable M does not represent the decimal-point digit position (NO in step S63), generation unit 410 stores, in the N-th digit of transmission buffer 504, the code of the M-th digit read from display register 503 (step S65).

After this, the value of variable N is incremented by one and the value of variable M is also incremented by one (step S67). After this, the process flow returns to step S61.

In step S63 again, when it is determined that the M-th digit represents the decimal-point digit position (YES in step S63), generation unit 410 stores in the N-th digit of transmission buffer 504 the character code of the decimal point (step S69). Then, variable N is incremented by one (step S71). After this, the process flow returns to step S61. The process of steps S61 to S71 is repeated and accordingly, in transmission buffer 504, a character code string of numerical values of 12 digits including the space code(s) [SP] and including the decimal point character code at an appropriate position is stored.

When it is determined in step S61 that the conditional expression (M>the number of digits to be displayed) is met (YES in step S61), the process flow proceeds to step S73.

Generation unit 410 stores the control code [→] in the M-th digit of transmission buffer 504. Then, variable M is incremented by one (step S73). Then, in the M-th digit of transmission buffer 504, a space code [SP] is stored, and the value of variable M is incremented by one (step S75).

After this, generation unit 410 reads the character code of the operator from operator register 502, and stores the read character code in the M-th digit of transmission buffer 504. Then, to variable M, the value (M+operator data length) is set (step S77). The value of variable M after the value is set in step S77 represents the number of codes (number of digits) of control-codes-mixed information including the character codes of the numerical values, decimal point, and operator stored in transmission buffer 504, and the relevant control codes.

Generation unit 410 stores, from the M-th digit of transmission buffer 504, a control code [CR], a space code [SP], a control code [←], and a control code [DEL] in order (step S79). Accordingly, the control-codes-mixed information (code string) of transmission buffer 504 is updated (step S79). After this, the process flow returns to the process in FIG. 12. While the value of variable M is not incremented in step S79, the value of variable M may be incremented (namely “M+4→M”).

In the processes of FIGS. 12 and 13, generation unit 410 generates control-codes-mixed information in which numerical values and operator received by reception unit 411 and control codes for controlling display 107 are arranged in accordance with a predetermined rule, and stores this information in transmission buffer 504. Then, the control-codes-mixed information is read from transmission buffer 504 and transmitted through information transmission unit 412 to PC 100. Thus, each of control-codes-mixed information 61 to 64 shown in FIG. 7 is transmitted to PC 100.

At this time, the information based on the control-codes-mixed information in transmission buffer 504 is stored in print register 505, and printer 406 is controlled in accordance with the information in print register 505. Thus, the numerical values and operator received by reception unit 411 can be printed on a sheet of paper so that the arrangement of the numerical values and operator matches to the arrangement of the same numerical values and operator in each row which is output on display 107 of PC 100.

How to generate the contents of print register 505 is not limited to the method which generates the contents from the contents of transmission buffer 504. Specifically, in the case where transmission buffer 504 stores a code string including control codes for display while print register 505 stores a code string for print that does not include the control codes for display (a code string for print as in the conventional printer calculator), a code string representing numeric keys and operator key based on operated keys as well as the result of arithmetic operation is stored in both transmission buffer 504 and print register 505. In transmission buffer 504, the control codes for display are further stored. Namely, in transmission buffer 504 and print register 505, data having been generated through different processes based on the operated keys are stored. The data of print register 505 may be generated based on the contents of transmission buffer 504, and the data of transmission buffer 504 may be generated from the contents of print register 505.

### Second Embodiment

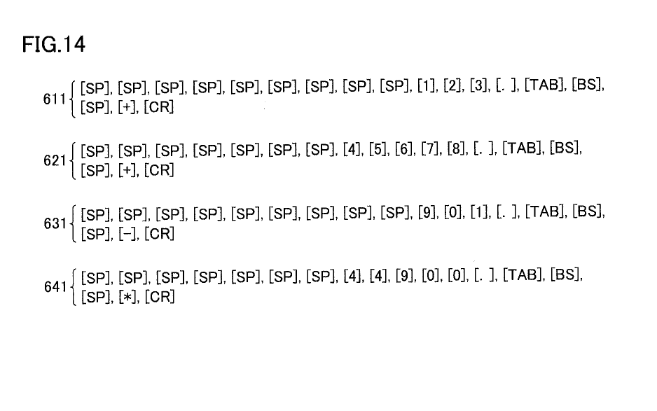

A modification of the first embodiment will be described. The control-codes-mixed information used for implementing the arrangement of numerical values and operators shown in FIG. 6 is not limited to the information shown in FIG. 7, and may be control-codes-mixed information 611, 621, 631, and 641 in FIG. 14. In accordance with control codes of the control-codes-mixed information in FIG. 14 that is received from calculator 400, PC 100 executes a program (text editor 201 or table generator 202) for controlling display 107, to thereby enable different programs (text editor 201 and table generator 202) to match to each other, in terms of the arrangement of the numerical values and operator in each row displayed on display 107.

Control-codes-mixed information 611, 621, 631, and 641 in a second embodiment correspond respectively to control-codes-mixed information 61, 62, 63, and 64 in the first embodiment in FIG. 7. It is seen from a comparison between the control-codes-mixed information in FIG. 14 and the corresponding control-codes-mixed information in FIG. 7 that they are different from each other in terms of the types of control codes and how they are arranged.

Specifically, the control code [→] immediately after the decimal point character code in the control-codes-mixed information of FIG. 7 is replaced with a tab code [TAB] which is a control code of a type different from this and a backspace control code [BS] in FIG. 14. In addition, the space code [SP], the control code [←], and the control code [DEL] which are located immediately after the control code [CR] in the control-codes-mixed information of FIG. 7 are not included in FIG. 14. The rule regarding the arrangement of other character codes and control codes (the rule according to which the space code(s) [SP] is arranged before numerical values for the sake of right justification by text editor 201 and the space code [SP] and the control code [CR] are arranged before and after the character code of the operator) is similar to that of the first embodiment.

Following the above-described rule of arranging the tab code [TAB] and the control code [BS] before the character code of the operator, table generator 202 controls the cursor so that the cursor is moved to the adjacent cell in accordance with the tab code [TAB], and ignores the control code [BS]. Thus, the cursor position is the same as that in the first embodiment. Text editor 201 deletes tab code [TAB] in accordance with its immediately subsequent control code [BS]. Thus, the cursor position is also the same as that in the first embodiment. Because no control code is arranged immediately after the control code [CR], the cursor position is kept at the beginning of the next row by the control code [CR]. This is the same as the position of cursor CR controlled by the space code [SP], the control code [→], and [DEL] in the first embodiment.

As seen from the above, although the types of control codes and the rule for arranging character codes that are applied for generating the control-codes-mixed information of the second embodiment differ from those of the first embodiment, the output operation of display 107 is controlled in accordance with the control-codes-mixed information in FIG. 14 to thereby enable the arrangement of numerical values and operators in the display area to be similar to the first embodiment (see FIGS. 6 and 8).

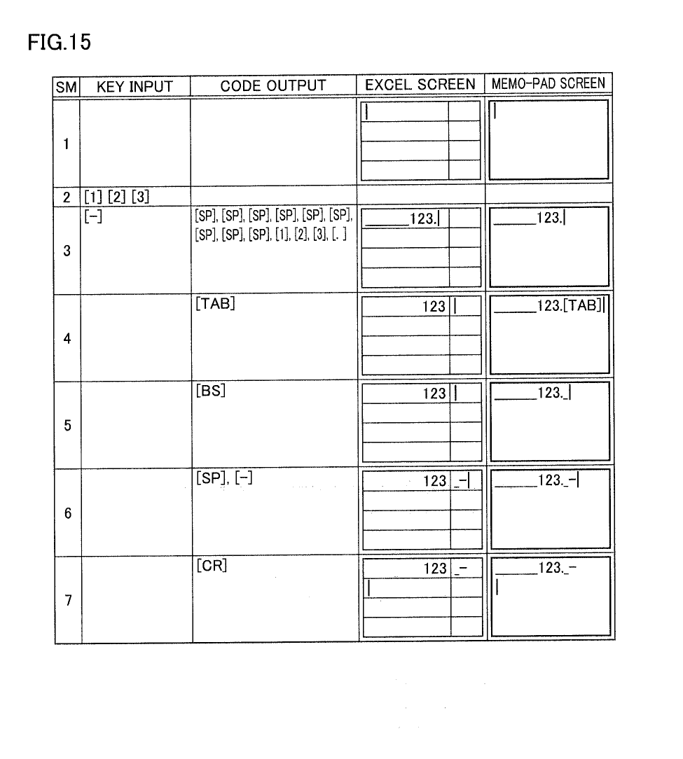

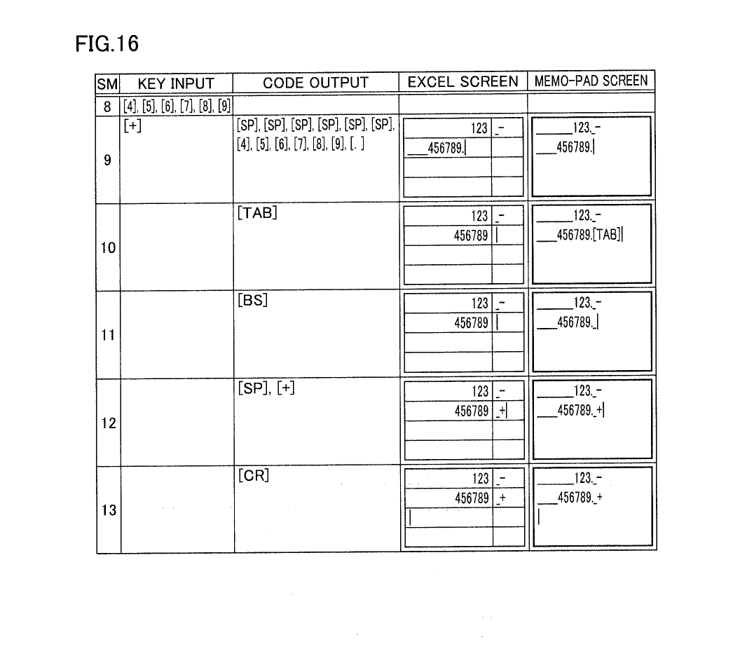

FIGS. 15 to 17 show interrelations of information in the case where control-codes-mixed information is generated in accordance with the above-described rule. Each set in FIGS. 15 to 17 includes, similarly to FIGS. 9 to 11 in the first embodiment, an identification number SM, a key input indicating key(s) operated by a user, a code output indicating an arrangement of codes generated by generation unit 410 in accordance with the key input, and an Excel screen and a memo-pad screen which are example screens displayed in accordance with the code output. The sets are herein identified by identification numbers SM1 to SM18, respectively.

Generation unit 410 generates, in accordance with the key input, the control-codes-mixed information indicated by sets SM1 to SM18, and the generated control-codes-mixed information is transmitted to PC 100. In accordance with the received control-codes-mixed information, PC 100 runs text editor 201 or table generator 202, and accordingly a screen (memo-pad screen or Excel screen) is displayed on display 107 in accordance with the received control-codes-mixed information. In these display screens, the information is displayed so that the screens match to each other in terms of the arrangement of numerical values and operator in each row (see set SM18). Thus, the control-codes-mixed information generated by generation unit 410 enables different programs (text editor 201 and table generator 202) to match to each other in terms of the arrangement of numerical values and operator in each row displayed on the screens (Excel screen and memo-pad screen).

### Third Embodiment

A third embodiment is a variation of the first embodiment. In the third embodiment, calculator 400 generates control-codes-mixed information so that an arrangement of numerical values on an Excel screen matches to an arrangement of the numerical values printed by calculator 400, regardless of the number of digits of an integer and regardless of whether or not numerical values have a fractional part.

### Overview of Process Procedure

A description will be given, for example, of the case where a user operates keys of keyboard 405 which intend an arithmetic expression (123456780000+1234.5678) for dividing the 12-digit integer (123456780000) by an integer with a decimal point (1234.5678). This integer with a decimal point is made up of an integer part (1234) and a fractional part (5678) with the decimal point interposed therebetween.

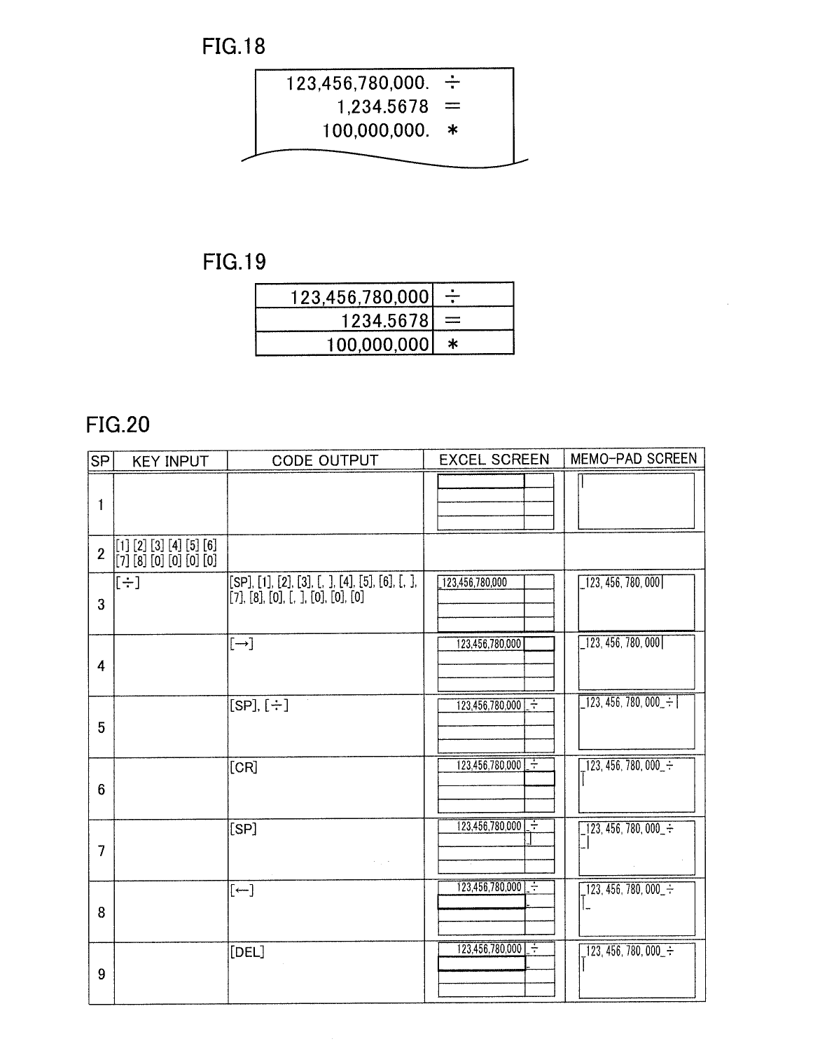

When CPU 401 calculates the arithmetic expression which is based on the operated keys to find the solution 100000000, an arrangement of the numerical values and operators in two columns×three rows is displayed or printed in which the numerical values are displayed or printed on the left side and the operators are displayed or printed on the right side as shown in FIG. 18.

Based on the aforementioned operated keys, generation unit 410 generates control-codes-mixed information. Information transmission unit 412 transmits the generated control-codes-mixed information to PC 100. When PC 100 receives the control-codes-mixed information and the running program is text editor 201, text editor 201 controls the output operation of display 107 so that it displays the numerical values and operators while moving the cursor in accordance with the received control-codes-mixed information. Accordingly, the mathematical expression in the document format is displayed on display 107 as shown in FIG. 18. When the running program is table generator 202, table generator 202 displays the mathematical expression in the table format on display 107 as shown in FIG. 19, in accordance with the received control-codes-mixed information.

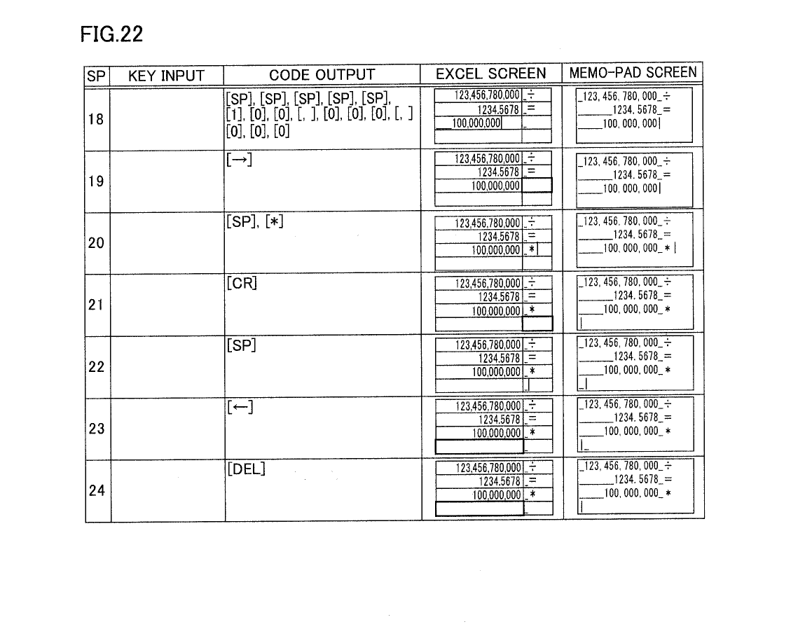

FIGS. 20 to 22 show interrelations of information using a plurality of sets. Each set includes an identification number SP, a key input indicating key(s) operated by a user, a code output indicating an arrangement of codes generated by generation unit 410 in accordance with the key input, and an Excel screen and a memo-pad screen which are example screens displayed in accordance with the arrangement of the code output. These sets are herein identified by identification numbers SP1 to SP24, respectively.

On the Excel screens of FIGS. 20 to 22, a cell enclosed by a thick frame is a focused cell. In the subsequent embodiments as well, a cell enclosed by a thick frame on an Excel screen is a focused cell. In the first and second embodiments, movement from one cell to another cell is accompanied by display of a cursor (see sets SN1 and SN4 for example in FIG. 9). This movement, however, may be accompanied by focusing of a cell without display of a cursor as in the third embodiment.

A description will first be given of the case where a user operates keys corresponding to the first row in FIG. 18 in the condition where the user has not operated keys for input (see set SP1 in FIG. 20). Specifically, the user operates keys for entering numerical values “123456780000” (see set SP2) and subsequently operates a key for entering an operator “÷” and accordingly, generation unit 410 generates a code string including three commas for separating every three digits of the numerical values (the comma is hereinafter referred to as 3-digit separator) (see set SP3). In the case where generation unit 410 generates a code string of numerical values, generation unit 410 places a space code(s) [SP] before the numerical-value code string for adjusting the number of digits. For example, supposing that printer 406 is a 16-digit printer, one space code [SP] is set in this case. The space is provided for right justification of numerical values to be displayed by text editor 201 (see the memo-pad screen of set SP3). The program of table generator 202 ignores the space code [SP] (see the Excel screen of set SP3). The number of digits to be printed is not limited to 16 digits, and may be 17 digits or more.

Following the numerical values “123456780000” the operator (÷) is entered by the key. Then, the code output of set SP3 is obtained.

Before the operator (÷) code is transmitted, generation unit 410 generates codes so that the control code [→] for moving the cursor to the right of the character string and the space code [SP] are located side by side (see sets SP4 and SP5). Instead of the control code [→], the tab code [TAB] and the control code [BS] may be used like the second embodiment.

Subsequently, generation unit 410 generates a code so that the next row is started subsequent to the operator (÷) code. Specifically, generation unit 410 outputs the control code [CR], the space code [SP], the control code [←], and the control code [DEL] so that they are located next to the operator (÷) (see sets SP6 to SP9). These codes are output similarly to sets SN6 to SN9 in FIG. 9. The description thereof will therefore not be repeated.

In this way, generation unit 410 generates the control-codes-mixed information which is a code string in which the character codes of the numerical values, operator, and 3-digit separators and the control codes are mixed. The generated control-codes-mixed information is transmitted to PC 100. PC 100 analyzes the code string of the received control-codes-mixed information from the beginning thereof (in the order of reception), and displays the character string based on the results of analysis while controlling the cursor position. In the case where the running program is table generator 202, table generator 202 analyzes the code string and displays, based on the results of the analysis, the string of the numerical values including the 3-digit separators (commas) on display 107. Accordingly, the Excel screen and the memo-pad screen can be matched to each other in terms of the arrangement of the numerical values and operator indicated by the control-codes-mixed information (see set SP9). In addition, the arrangement of the character string of the numerical values and operator in each row on the display screen of set SP9 can be matched to the arrangement of the character string of the numerical values and operator in each row printed by printer 406 shown in FIG. 18.

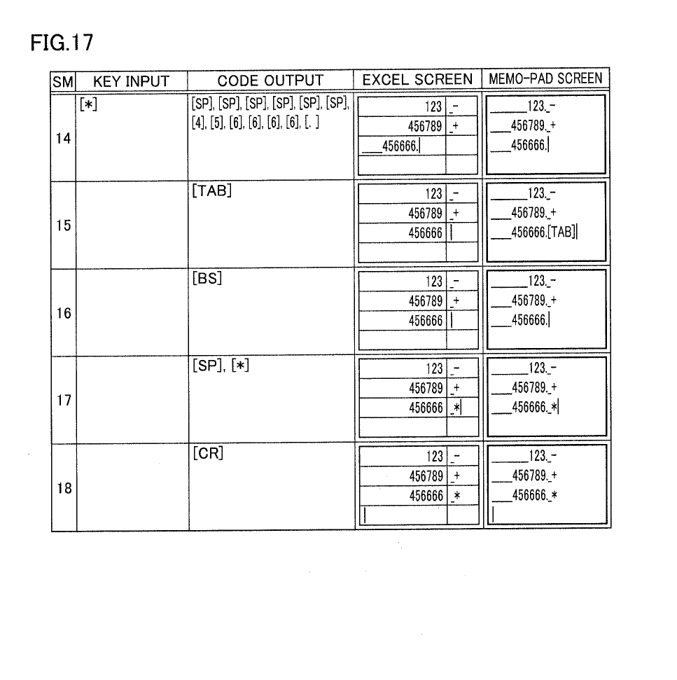

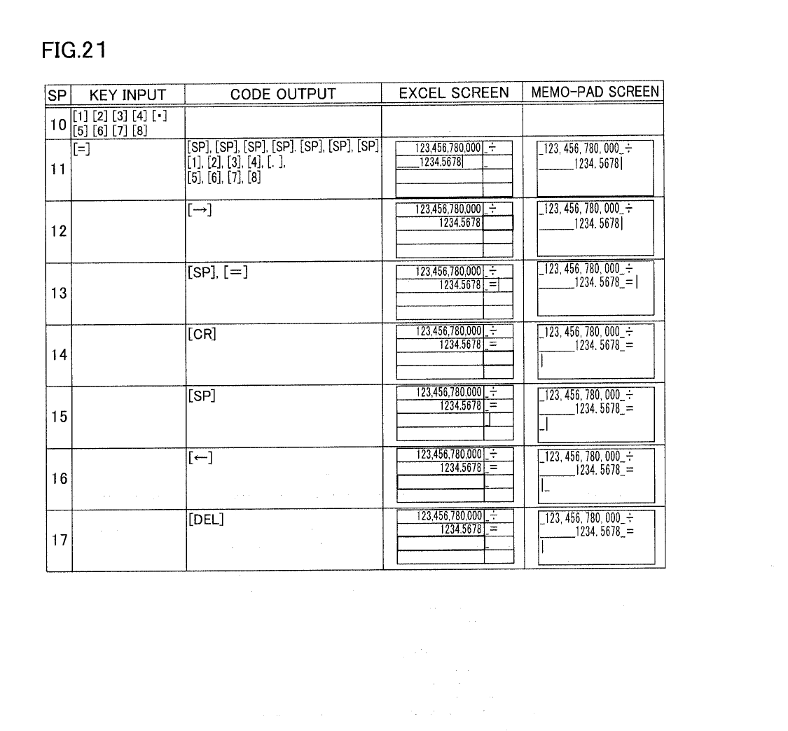

Subsequently, in the case where “1234.5678” and “=” corresponding to the second row in FIG. 17 is to be transmitted, generation unit 410 generates the codes as indicated by sets SP10 to SP17 in FIG. 21, and transmits control-codes-mixed information based on the generated codes to PC 100.

First, keys are operated to input numerical values “1234.5678” (see set SP10), and subsequently a key is operated to input the operator “=”. Then, generation unit 410 generates a code string including the numerical values of the integer part, the decimal point, and the numerical values of the fractional part (see set SP11). Generation unit 410 sets seven space codes [SP] before the code string so that the number of digits of the code string is 16 digits.

Then the key of the operator (=) following the numerical values “1234.5678” is operated, and accordingly the control-codes-mixed information of set SP11 is transmitted.

Before the operator (=) code is transmitted, generation unit 410 generates codes so that the control code [→] and the space code [SP] are located side by side in sets SP12 to SP17. After this, generation unit 410 generates a control code [CR], a space code [SP], a control code [←], and a control code [DEL] so that they are located next to the operator (=). These codes are output similarly to sets SN6 to SN9 in FIG. 9. The description thereof will therefore not be repeated.

In this way, generation unit 410 generates the control-codes-mixed information which is a code string in which the numerical values, operator, decimal point, and control codes are mixed, and the generated control-codes-mixed information is transmitted to PC 100. PC 100 analyzes the code string of the received control-codes-mixed information from the beginning thereof (in the order of reception), and performs the display process based on the results of analysis while controlling the cursor position.

In general, an Excel screen displayed by the Excel program shows, in the case of an integer with a decimal point including 3-digit separator(s) in its integer part, this integer with a decimal point after rounding off the third digit of its fractional part next to the decimal point. Namely, numerical values “1234.5678” are changed to “1234.57” and displayed. As a result, the arrangement of the numerical values included in the integer with a decimal point printed by printer 406 and the arrangement of the numerical values of the same integer with a decimal point displayed on the Excel screen do not match to each other.

In contrast, in the third embodiment, control-codes-mixed information for an integer with a decimal point is generated so that the integer part does not include 3-digit separator(s) as shown in set SP11. Thus, even when the running program is table generator 202, table generator 202 does not perform rounding-off for display based on this control-codes-mixed information. Accordingly, on this Excel screen based on the control-codes-mixed information, the integer with a decimal point “1234.5678” on which rounding-off has not been done can be displayed without aforementioned mismatch (see sets SP11 to SP17).

After this, the arithmetic operation's result “100000000” and “*” are transmitted as shown in sets SP18 to SP24 in which control-codes-mixed information is generated by generation unit 410 similarly to sets SP2 to SP9. The generated control-codes-mixed information is transmitted to PC 100. PC 100 displays information based on the received control-codes-mixed information.

In this way, regardless of whether the result of an arithmetic operation is the result of an arithmetic operation performed on an integer with a decimal point which includes 3-digit separator(s) or on a number which is not an integer with a decimal point, an arrangement of numerical values and operator in each row printed on a sheet of paper by printer 406 and that on an Excel screen can be matched to each other. Likewise, an arrangement of numerical values and operator in each row on the Excel screen and that on the memo-pad screen can be matched to each other (see sets SP11 to SP17 and SP24).

### Process Flow

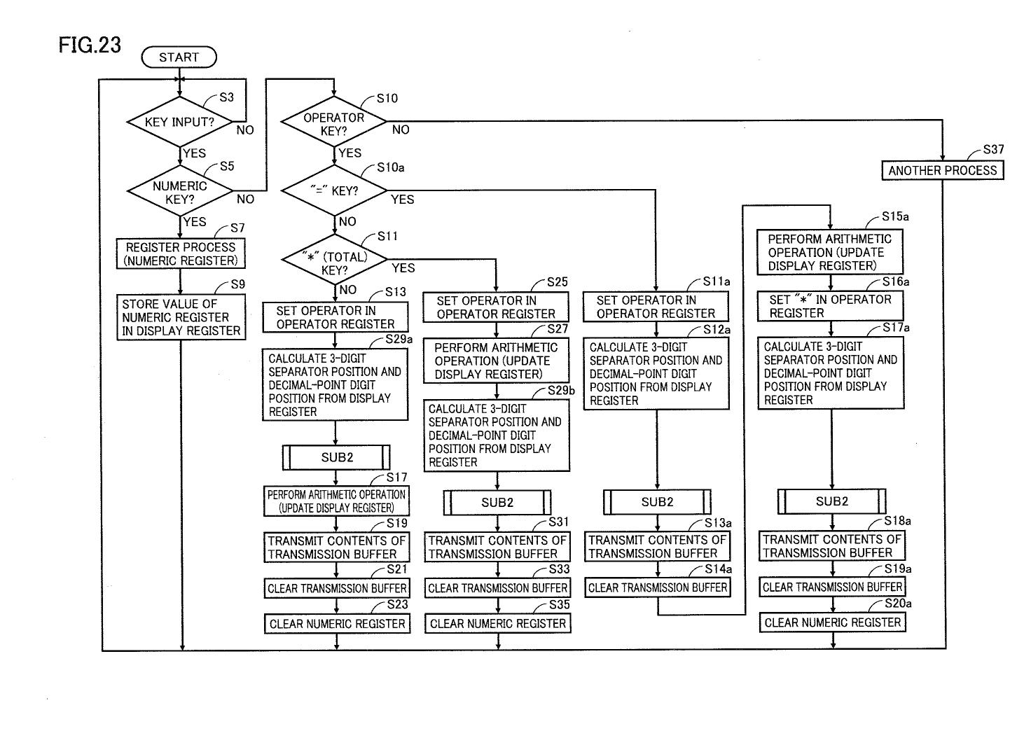

Referring to FIGS. 23 to 25, generation of the control-codes-mixed information described above with reference to FIGS. 20 to 22 and transmission of the control-codes-mixed information to PC 100 will be described. The flowcharts have been stored as programs in storage unit 402 in advance. CPU 401 reads the programs from storage unit 402 and executes the read programs.

The flowchart in FIG. 23 includes processes common to those of the flowchart in FIG. 12. The common processes will briefly be described or the above description of the common processes will not be repeated. Mainly the processes (steps S10a to S20a, steps S29a and 29b, and Process SUB2) different from FIG. 12 will be described.

A variety of registers and buffers like those of the first embodiment are also used and they have been cleared (initialized) in advance.

First, steps S3 to S9 are performed similarly to the first embodiment. Specifically, generation unit 410 generates a character code representing a numerical value based on a key code of a key operated by a user, and stores the generated character code in numeric register 501. Generation unit 410 also stores the character code in display register 503 (step S9). When it is determined that the key code of the key operated by the user is the key code of operator key 602 operated by the user (YES in step S10), generation unit 410 determines from the key code whether or not the operator key is the “=” key (step S10a). When it is determined that it is not the “=” key (NO in step S10a), generation unit 410 determines whether or not the operator key is the “*” key (step S11). When it is determined that the operator key is not the “*” key (NO in step S11), the character code representing this operator key is stored in operator register 502 (step S13).

Then, generation unit 410 calculates, from a character string of numerical values indicated by the contents (a character code string) stored in display register 503, the decimal-point digit position and the position(s) where the 3-digit separator (comma) should be set (step S29a). For example, generation unit 410 counts the number of digits (number of characters) from the last digit to the first digit of the character string represented by the character code string to calculate the position for separating every three digits and the decimal-point digit position.

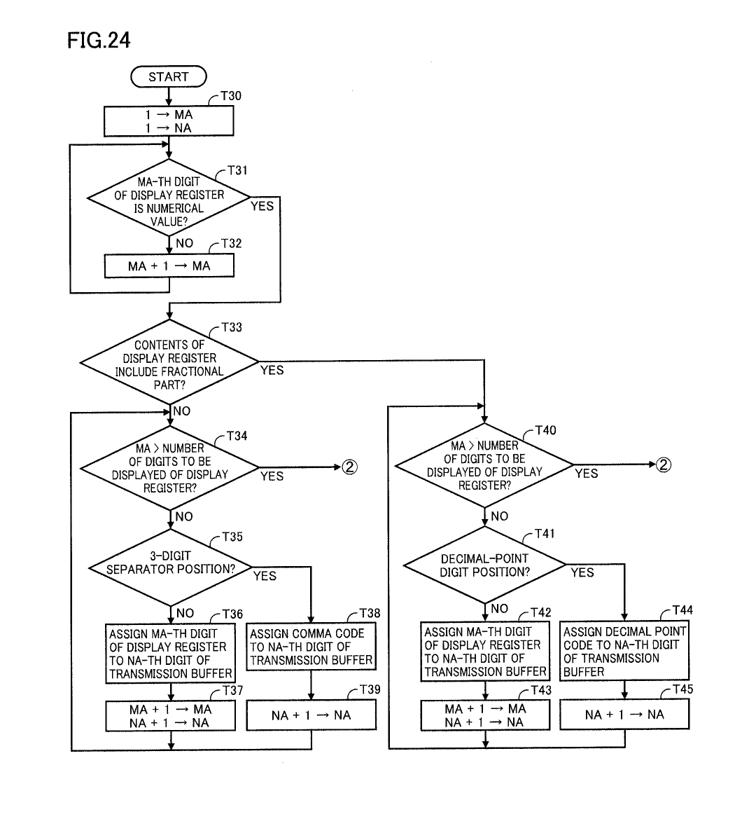

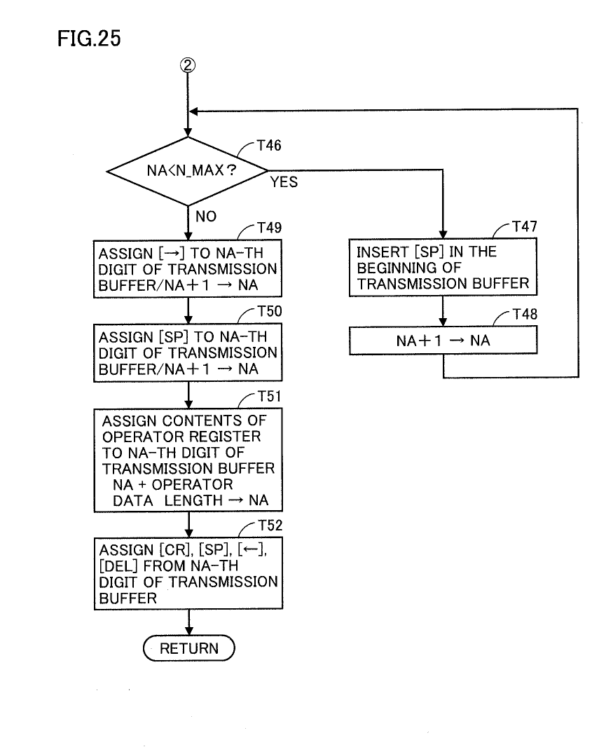

Subsequently, generation unit 410 generates, from the contents of display register 503, control-codes-mixed information and stores the generated control-codes-mixed information in transmission buffer 504. This process is referred to as Process SUB2. Process SUB2 will be described later herein with reference to FIGS. 24 and 25.

After this, CPU 401 uses an arithmetic function to perform an arithmetic process in accordance with an arithmetic expression indicated by the contents of numeric register 501 and operator register 502. Then, a character code string representing a numerical value which is the result of calculation of the arithmetic process is stored in display register 503. Accordingly, the contents of display register 503 are updated (step S17). At this time, the character code string in display register 503 represents the numerical value which is the result of the arithmetic operation using the numerical values and operator input through the keys.

After this, CPU 401 reads the control-codes-mixed information from transmission buffer 504 and transmits the read control-codes-mixed information to PC 100 (step S19). After this, transmission buffer 504 is cleared (step S21) and numeric register 501 is cleared (step S23). After this, the process flow proceeds to step S3.

In step S11 again, when generation unit 410 determines that the operated operator key is the “*” key (YES in step S11), generation unit 410 stores in operator register 502 the character code represented by the key code of the operator key (step S25). After this, CPU 401 uses the arithmetic function to perform an arithmetic process in accordance with an arithmetic expression indicated by the contents of the numeric register 501 and operator register 502. A character code string representing the value of the result of execution of the arithmetic process is stored in display register 503 and accordingly the contents of display register 503 are updated (step S27). After this, generation unit 410 calculates, from the contents of display register 503, the position(s) of the 3-digit separator and the decimal-point digit position (step S29b). Process SUB2 is thereafter executed.

In Process SUB2, generation unit 410 updates the control-codes-mixed information of transmission buffer 504. The updated control-codes-mixed information is transmitted to PC 100 (step S31). After this, transmission buffer 504 and numeric register 501 are cleared (steps S33, S35). After this, the process flow returns to step S3.

In step S10a again, when generation unit 410 determines from the input key code that the operator key is the “=” key (YES in step S10a), generation unit 410 stores the character code of this operator key in operator register 502 (step S11a), and calculates from the contents of display register 503 the position(s) of the 3-digit separator and the decimal-point digit position (step S12a). Process SUB2 is thereafter executed. The processes of steps S11a and S12a are similar to those of steps S13 and S29a, and therefore the description of the details will not be repeated.

Process SUB2 updates the control-codes-mixed information in transmission buffer 504. The updated control-codes-mixed information is transmitted to PC 100 (step S13a) and transmission buffer 504 is cleared (step S14a). The processes of steps S13a and S14a are similar to the processes of steps S19 and S21, and therefore the description of the details will not be repeated.

After this, an arithmetic process in accordance with an arithmetic expression indicated by the contents of numeric register 501 and operator register 502 is performed, and a character code string representing the numerical value obtained by calculating the arithmetic expression is stored in display register 503 (step S15a). The character code representing the operator key “*” is also stored in operator register 502 (step S16a). After this, from the character string of numerical values indicated by the contents stored in display register 503, the decimal-point digit position and the position(s) where the 3-digit separator (comma) should be set are calculated (step S17a). Process SUB2 is thereafter executed. After this, CPU 401 transmits the control-codes-mixed information read from transmission buffer 504 to PC 100 (step S18a), clears the contents of transmission buffer 504 (step S19a), and clears numeric register 501 (step S20a). After this, the process flow proceeds to step S3. The processes of steps S15a, S16a, S17a, S18a, S19a, and S20a are similar to the processes of the above-described steps S17, S13, S29a, S19, S21, and S23, and therefore the description thereof will not be repeated.

### Process SUB2

Referring to FIGS. 23 and 24, Process SUB2 in the third embodiment will be described. In Process SUB2, variables MA and NA which are temporary variables for controlling the process are used. Variables MA and NA each represent a predetermined storage area of storage unit 402. Variable MA is a variable to which the count value of the number of digits (number of characters) of a character code string stored in display register 503 is set (the count value is stored in the associated storage area). Variable NA is a variable to which the count value of the number of digits (number of characters) of a character code string stored in transmission buffer 504 is set (the count value is stored in the associated storage area). A variable N_MAX represents the maximum number of characters (including 3-digit separator(s) and decimal point) that can be stored in transmission buffer 504. Integers used herein have a maximum of 12 digits. Therefore, the maximum number of characters that can be stored is 16 characters (12+(12/3)=16).

First, generation unit 410 sets initial value 1 to variables MA and NA (step T30). Subsequently, it is determined, from the contents stored in display register 503, whether or not a character code of an MA-th digit, namely the MA-th character code from the beginning, is a character code of a numerical value (step T31). When it is determined that it is not a character code of a numerical value (NO in step T31), the value of variable MA is incremented by one (step T32). The process flow thereafter returns to step T31.

The process of steps T30 to T32 is repeated and accordingly the ordinal position of the digit with respect to the beginning of display register 503, from which a character code string of numerical values in display register 503 starts, is detected. The detected ordinal position of the digit with respect to the beginning thereof is represented by the value of variable MA.

When it is determined that the MA-th digit of display register 503 is a character code of a numerical value (YES in step T31), generation unit 410 determines, based on whether or not the decimal point is detected from the character code string of display register 503, whether or not the character code string includes a fractional part (step T33). When it is determined that the fractional part is not included (NO in step T33), the character code string of display register 530 that does not include the fractional part is stored in transmission buffer 504 (steps T34 to T39). In contrast, when it determines that the fractional part is included (YES in step T33), the character code string of display register 503 including the fractional part is stored in transmission buffer 504 (steps T40 to T45).

First, steps T34 to T39 will be described. Generation unit 410 determines whether or not a conditional expression (MA>the number of digits to be displayed of display register 503) is met (step T34). In the present embodiment, the number of digits to be displayed in this conditional expression is 16 digits.

When generation unit 410 determines that the condition is met (YES in step T34), the process flow proceeds to step T46 described later herein. When generation unit 410 determines that the condition is not met (NO in step T34), generation unit 410 determines whether or not the value of variable MA represents the position of the 3-digit separator (the number of digits calculated in steps S29a, S29b, S12a, S17a) (step T35). When it is determined that the value of variable MA does not represent the position of the 3-digit separator (NO in step T35), generation unit 410 stores, in the NA-th digit of transmission buffer 504, the code of the MA-th digit read from display register 503 (step T36).

After this, the value of variable NA is incremented by one, the value of variable MA is also incremented by one (step T37), and the process flow returns to step T34.

In step T35 again, when generation unit 410 determines that the value of variable MA represents the position of the 3-digit separator (YES in step T35), generation unit 410 stores, in the NA-th digit of transmission buffer 504, the character code of comma representing the 3-digit separator (step T38). After this, variable NA is incremented by one (step T39). The process flow returns to step T34.

In this way, the process of steps T34 to T39 is repeated and accordingly, the character code string of display register 503 in which the character code(s) of comma is inserted for every three digits is stored in transmission buffer 504.

Next, steps T40 to T45 will be described. Generation unit 410 determines whether or not a conditional expression (MA>the number of digits to be displayed of display register 503) is met (step T40).

When it is determined that the condition is met (YES in step T40), the process flow proceeds to step T46 described later herein. When it is determined that the condition is not met (NO in step T40), generation unit 410 determines whether or not the value of variable MA represents the decimal-point digit position (the number of digits calculated in steps S29a, S29b, S12a, S17a) (step T41). When it is determined that the value of variable MA does not represent the decimal-point digit position NO in step T41), generation unit 410 stores in the NA-th digit of transmission buffer 504, the code of the MA-th digit read from display register 503 (step T42), and respective values of variables NA and MA are incremented by one (step T43). After this, the process flow returns to step T40. The process of steps T42 and T43 is similar to that of steps T36 and T37.

In step T41 again, when it is determined that the value of variable MA represents the decimal-point digit position (YES in step T41), generation unit 410 stores, in the NA-th digit of transmission buffer 504, the character code representing the decimal point (this character code will hereinafter be also referred to as decimal point code) (step T44). After this, variable NA is incremented by one (step T45). The process flow returns to step T40.

The process of steps T40 to T45 is repeated and accordingly, the character code string of display register 503 in which the decimal point code is inserted to the digit indicated by the decimal-point digit position is stored in transmission buffer 504. This decimal point code corresponds to the separator code used for expressing an integer or the like by separating every three digits.

Referring to FIG. 25, generation unit 410 determines whether or not the value of variable NA updated by the process in FIG. 24 meets a condition (NA<N_MAX) (step T46). When generation unit 410 determines that this condition is met, namely the number of characters of the character code string stored in transmission buffer 504 is less than 16 (YES in step T46), generation unit 410 changes the NA-th character from the beginning of transmission buffer 504, namely the NA-th digit, to a space code [SP] (step T47). After this, the value of variable NA is incremented by one (step T48), and the process flow returns to step T46. The process of steps T46 to T48 is repeated and accordingly, like steps S55 and S57 in FIG. 13, the space code(s) [SP] is stored from the beginning of transmission buffer 504 for adjusting the character code string of the numerical values of display register 503 to the aforementioned 16 digits.

In contrast, when generation unit 410 determines that the condition (NA<N_MAX) is not met, namely the number of characters of the character code string stored in transmission buffer 504 is “16” (NO in step T46), generation unit 410 performs a similar process to the process of steps S73 to S79 of FIG. 13. Namely, generation unit 410 stores, in the NA-th and its subsequent digits of transmission buffer 504, control code [→], space code [SP], the character code of the operator read from operator register 502, control code [CR], space code [SP], control code [←], and control code [DEL] in this order (steps T49 to T52). After this, the process flow returns to the process in FIG. 23.

In the processes of FIGS. 23 to 25, generation unit 410 generates control-codes-mixed information in which numerical values and operator or decimal point received by reception unit 411 and control codes used for controlling the operation of outputting information to display 107 by PC 100 are arranged in accordance with a predetermined rule. The generated control-codes-mixed information is stored in transmission buffer 504. Information transmission unit 412 then transmits the control-codes-mixed information in transmission buffer 504 to PC 100. Accordingly, in the case of an integer of 12 digits or more as shown in FIG. 18, the control-codes-mixed information representing the integer including 3-digit separators is transmitted to PC 100. In the case of an integer with a decimal point as shown in FIG. 18, the control-codes-mixed information representing the integer with a decimal point that does not include 3-digit separators is transmitted to PC 100.

At this time, the information based on the control-codes-mixed information in transmission buffer 504 is stored in print register 505. Printer 406 is controlled in accordance with the information in print register 505. Thus, the numerical values and operator or decimal point received by reception unit 411 can be printed so that the arrangement of the numerical values and operator or decimal point matches to the arrangement of the same numerical values and operator or decimal point to be output to display 107.

In general, the Excel program uses an exponent for displaying an integer of 12 digits or more that does not include 3-digit separators (commas). Therefore, in the case of an integer of 12 digits or more, what is printed/displayed by calculator 400 and what is displayed by display 107 do not match to each other.

In contrast, calculator 400 of the third embodiment generates control-codes-mixed information for an integer so that the integer includes the 3-digit separator(s) (comma(s)). The generated control-codes-mixed information can be used to control table generator 202 so that it does not display the integer with an exponent. Accordingly, the third embodiment can avoid the aforementioned mismatch regarding display of an integer of 12 digits or more.

Further, in the case of an integer with a decimal point that includes the 3-digit separator(s) (comma(s)) in the integer part, the Excel program rounds off the third digit of its fractional part next to the decimal point and displays the resultant numerical value. Therefore, in the case of an integer with a decimal point, what is printed/displayed by calculator 400 and what is displayed by PC 100 do not match to each other.

In contrast, calculator 400 of the third embodiment generates control-codes-mixed information for an integer with a decimal point so that the integer does not include the 3-digit separator(s) (comma(s)). The generated control-codes-mixed information can be used to control table generator 202 so that it does not perform rounding-off. Accordingly, the third embodiment can avoid the aforementioned mismatch regarding display of an integer with a decimal point.

### Fourth Embodiment

A fourth embodiment is a variation of the first embodiment. In the above-described third embodiment, calculator 400 generates control-codes-mixed information including the 3-digit separator regardless of the total number of digits of numerical values. The fourth embodiment performs a process of determining whether to insert the 3-digit separator in a character code string of an integer, based on the total number of digits.

While the fourth embodiment differs from the third embodiment in that the former performs the process of determining whether to insert the 3-digit separator, other processes are similar to those of the third embodiment. Therefore, differences of the fourth embodiment from the third embodiment will mainly be described.

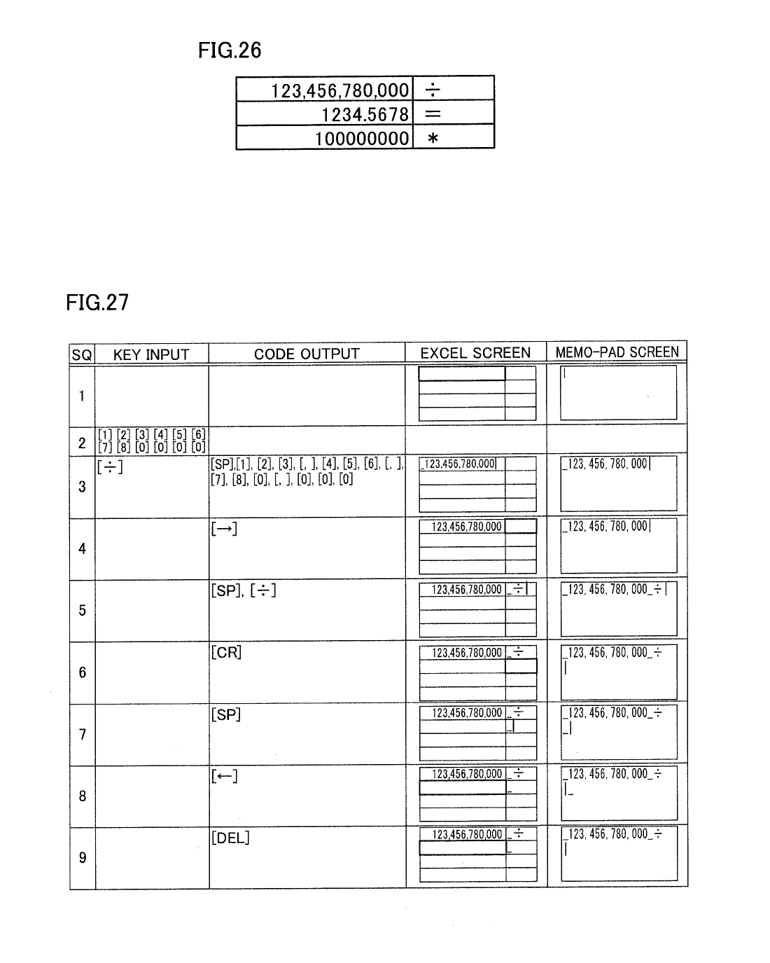

The fourth embodiment will also be described as being applied to the case where a user operates keys of keyboard 405 which intend an arithmetic expression (123456780000÷1234.5678). The arithmetic expression and the calculated value are displayed/printed as shown in FIG. 18. On display 107, the mathematical expression in the document format is displayed as shown in FIG. 18. When table generator 202 has been activated and is running, table generator 202 displays the received control-codes-mixed information in the table format as shown in FIG. 26.

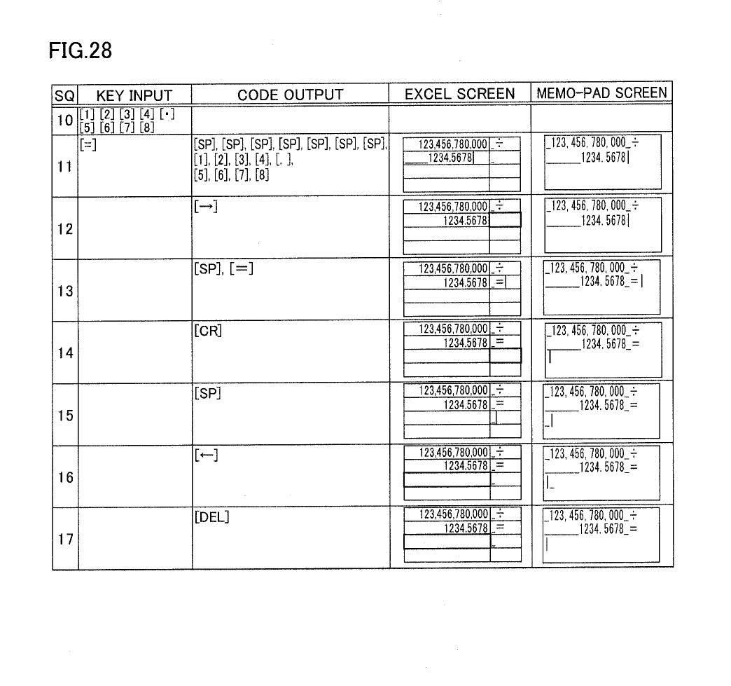

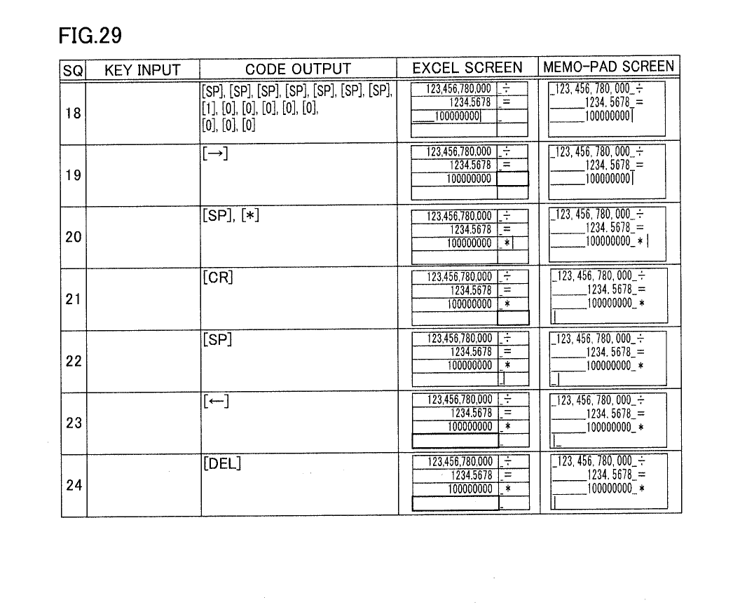

In FIGS. 27 to 29, a plurality of sets are used to show interrelations of information. Each set includes an identification number SQ, a key input indicating key(s) operated by a user, a code output indicating an arrangement of codes generated by generation unit 410 in accordance with the key input, and an Excel screen and a memo-pad screen which are example screens displayed in accordance with the arrangement of the code output. These sets are herein identified by identification numbers SQ1 to SQ24, respectively. From a comparison with sets SP1 to SP24 in the third embodiment, it is seen that the contents of set SQ18 in FIG. 29 are different from those of set SP18. Other sets SQ1 to SQ17 and sets SQ19 to SQ24 are identical to sets SP1 to SP17 and sets SP19 to SP24 in the third embodiment. Thus, set SQ18 will be described and the description of the remaining sets will not be repeated.

In set SQ18, control-codes-mixed information for “100000000” which is the result of the arithmetic operation is generated. Specifically, generation unit 410 determines that “100000000” has less than 12 digits and generates, based on the result of the determination, the control-codes-mixed information which does not include the character code of the 3-digit separator (comma). The generated control-codes-mixed information is transmitted to PC 100. On PC 100, based on the received control-codes-mixed information, the numerical values and operator in each row is displayed on the Excel screen and the memo-pad screen so that these screens are matched to each other in terms of the arrangement of the numerical values and operator (see set SQ24). As seen from set SQ24, the integer (123456780000) having 12 or more digits is displayed so that it includes the 3-digit separators (commas) while the integer (100000000) having less than 12 digits is displayed without the three-digit integers (commas).

### Process Flow

Referring to FIGS. 23, 30, and 31, generation of the control-codes-mixed information described above in connection with FIGS. 27 to 29 and transmission of the information to PC 100 will be described. The flowcharts of FIGS. 23, 30, and 31 have been stored as programs in storage unit 402 in advance. CPU 401 reads the programs from storage unit 402 and executes the read programs.

The flowchart of FIG. 23 is also applicable to the fourth embodiment. In the fourth embodiment, the step of “Process SUB2” included in the steps of FIG. 23 differs from the third embodiment, and the other steps are similar to the third embodiment. Therefore, the description of the other steps will not be repeated.

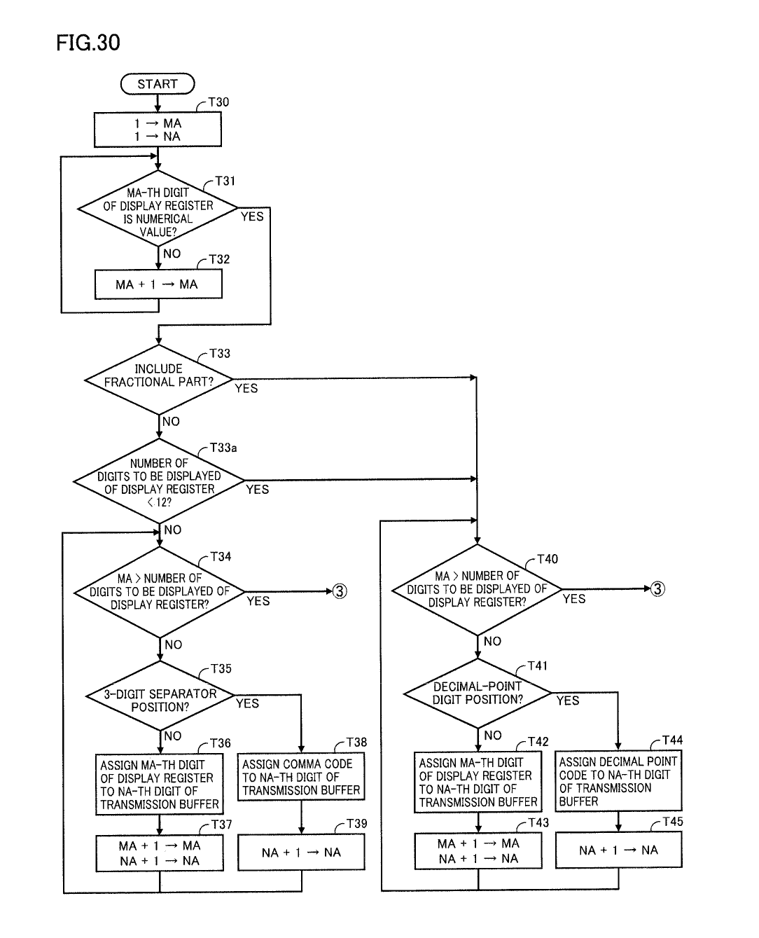

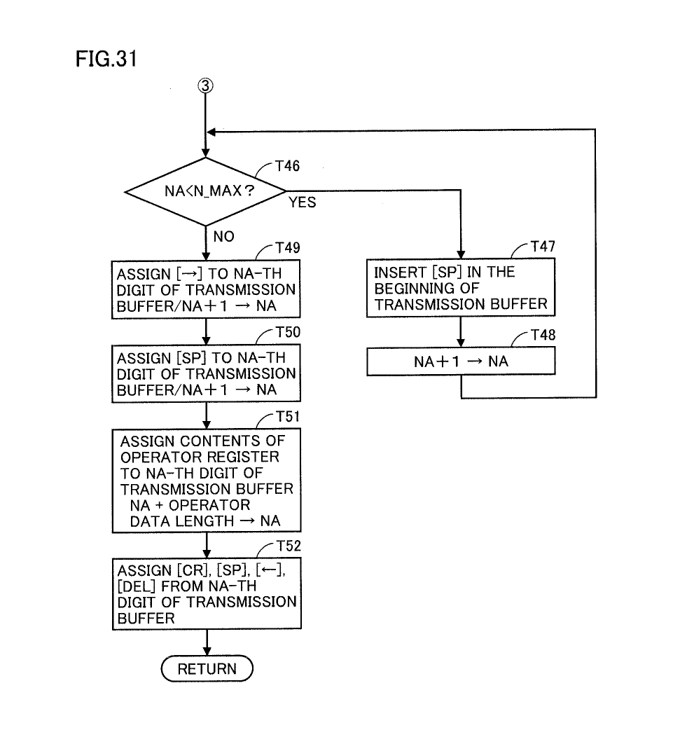

“Process SUB2” in the fourth embodiment is shown in FIGS. 30 and 31. While the processes in FIGS. 30 and 31 differ from the processes of the third embodiment (processes in FIGS. 24 and 25) in that step T33a is added, the other steps are similar to those of the processes of the third embodiment (processes in FIGS. 24 and 25). Therefore, step T33a will mainly be described, and the description of the other steps will not be repeated.

In step T33a, in the case where the numerical values of the character code string in display register 503 are numerical values which do not have a fractional part (NO in step T33), the number of digits of the numerical values is determined. Specifically, the number of digits (number of characters) of this character code string is counted, and it is determined whether or not the counted number of digits meets a condition (the number of digits<12) (step T33a). When it is determined that this condition is not met (NO in step T33a), step T34 and its subsequent steps are performed similarly to the third embodiment.

Namely, in the case where the number of digits of the numerical values stored in display register 503 is 12 digits or more, 3-digit separator (comma) codes are set at respective positions separating every three digits in the character code string of the numerical values. Therefore, in the case where the aforementioned 123456780000 is input, it is determined that this condition is not met (NO in step T33a), and generation unit 410 sets the 3-digit separator (comma) codes in the character code string of the numerical values.

In contrast, when it is determined that this condition is met (YES in step T33a), step T40 and its subsequent steps are performed similarly to the third embodiment. Namely, in the case where the number of digits of the numerical values stored in display register 503 is 11 digits or less, the step of setting 3-digit separator (comma) codes is not performed. Thus, in the case where the aforementioned 100000000 is calculated through the arithmetic operation, it is determined that this condition is met (YES in step T33a). Then, generation unit 410 does not set the 3-digit separator (comma) codes in the character code string representing the calculated value.

As described above, generally an Excel screen uses an exponent to display an integer of 12 digits or more which does not include 3-digit separators (commas). In view of this, in the case of an integer of 12 digits or more (NO in step T33a), the control-codes-mixed information is generated so that the integer includes 3-digit separators (commas). Accordingly, the mismatch between what is printed/displayed by calculator 400 and what is displayed by PC 100 can be avoided.

In the case of an integer of less than 12 digits (YES in step T33a), the control-codes-mixed information is generated so that the integer does not include 3-digit separators (commas). Therefore, the amount of information about the control-codes-mixed information can be reduced. Accordingly, the time required for transfer of the control-codes-mixed information to PC 100 can be shortened and the capacity of a buffer necessary for transmission/reception thereof can be reduced.

### Fifth Embodiment

A fifth embodiment is a variation of the third and fourth embodiments. Regarding the third and fourth embodiments, the method has been described above of how to match what is printed/displayed by calculator 400 and what is displayed by PC 100 to each other without depending on the display format which is set for table generator 202.

In contrast, in the fifth embodiment, calculator 400 transmits to PC 100 a code for the control-codes-mixed information that is a code for specifying setting information about display by a program of PC 100. Specifically, calculator 400 transmits a code for formatting display of table generator 202 to thereby avoid the aforementioned mismatch. The code for formatting includes a control code and a shortcut key code for executing a command to format Excel.

The following description of the fifth embodiment is also of the case where a user operates keys of keyboard 405 which intend an arithmetic expression (123456780000÷1234.5678). As shown in FIG. 18, this arithmetic expression and the calculated value are displayed/printed. In the case where the running program is text editor 201, display 107 shows the mathematical expression in the document format like FIG. 18. In the case where the running program is table generator 202, table generator 202 displays the mathematical expression in the table format like FIG. 19, in accordance with the received formatting code and control-codes-mixed information.

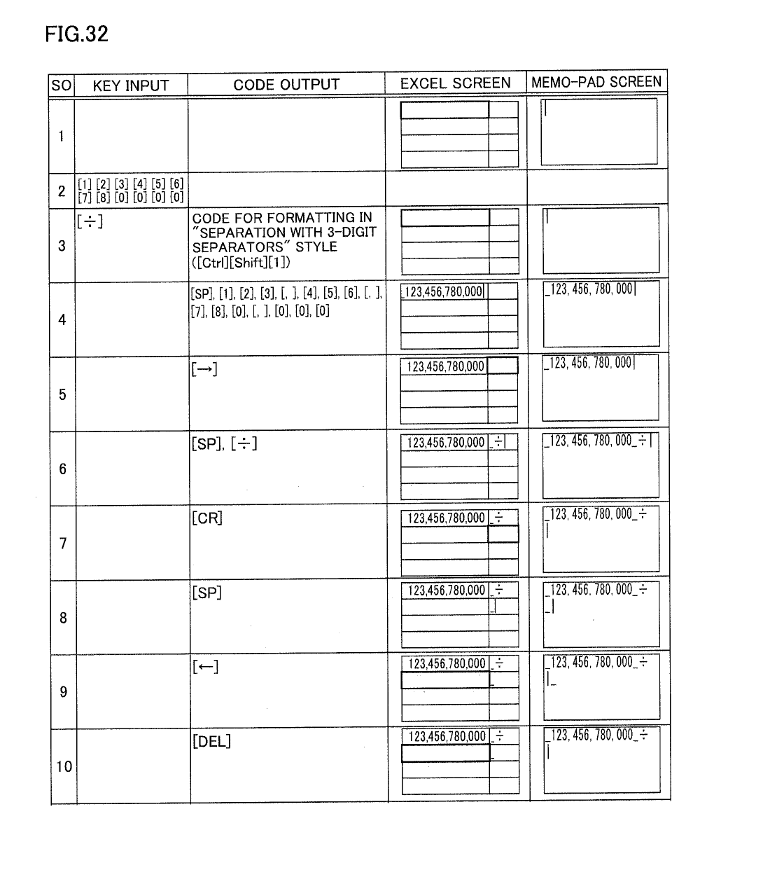

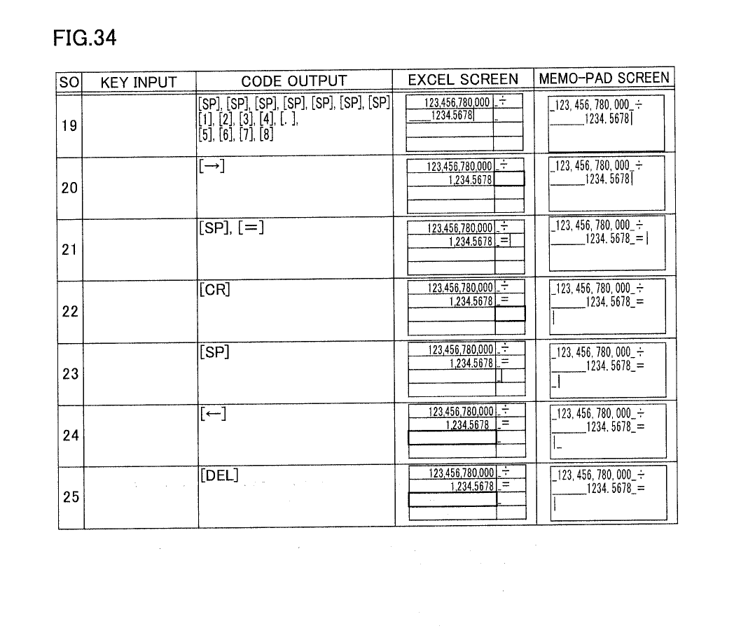

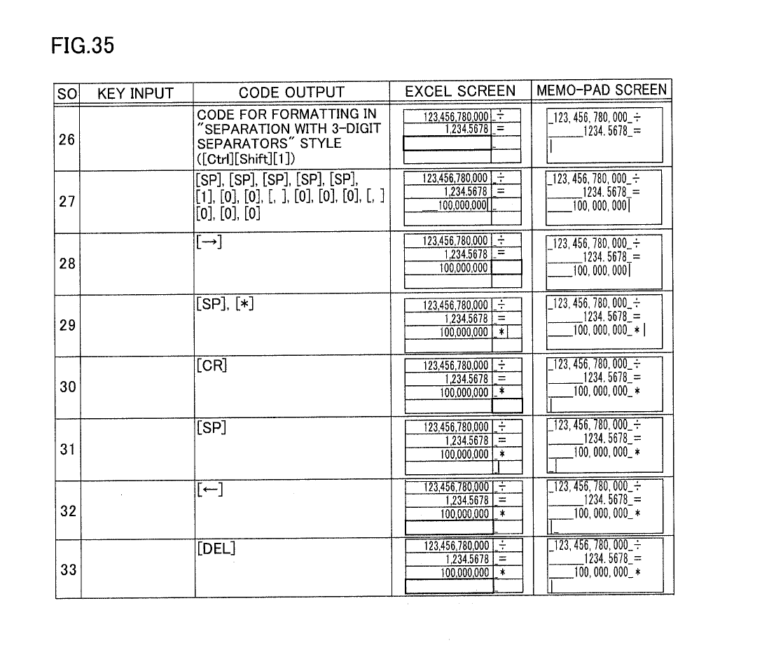

FIGS. 32 to 35 show interrelations of information using a plurality of sets. Each set includes an identification number SO, a key input indicating key(s) operated by a user, a code output indicating an arrangement of codes generated by generation unit 410 from the key input, and an Excel screen and a memo-pad screen which are example screens displayed in accordance with the arrangement of the code output. These sets are herein identified by identification numbers SO1 to SO33, respectively.

First, in the condition where no key input operation has been done (see set SO1 in FIG. 32), keys are operated to input numerical values “123456780000” (see set SO2) and subsequently a key is operated to input the operator “÷”. Then, generation unit 410 generates a shortcut key code ([Ctrl] [Shift] [1]) for formatting Excel in “separation with 3-digit separators” style (currency style). The generated shortcut key code is transmitted to PC 100. When the running program of PC 100 is table generator 202, table generator 202 is formatted in “currency style separated with digit separators” in accordance with the received shortcut key code. When the running program is text editor 201, the shortcut key code is invalid.

In the subsequent sets SO4 to SO10, the control-codes-mixed information of the character code string including 3-digit separators is generated similarly to sets SP3 to SP9 in FIG. 20, and the generated control-codes-mixed information is transmitted to PC 100.

Subsequently, in response to input of the integer with a decimal point “1234.5678” and “=” corresponding to the second row in FIG. 18, generation unit 410 generates the codes shown in sets SO12 to SO18. The generated codes are transmitted to PC 100. Set SO12 shows the above-described shortcut key code ([Ctrl] [Shift] [1]), and set SO13 shows a shortcut key code ([Ctrl] [Shift] [F]) for giving an instruction to start formatting. Set SO14 shows codes ([→] [→] [→] [→]) of keys operated for selecting a display format in formatting. Set SO15 shows codes ([Alt] [D]) of keys operated for specifying the number of digits of the fractional part. Set SO16 shows a numeric code ([4] for example) representing the number of digits of the fractional part. Set SO17 shows a code ([ENTER]) of the key operated for giving an instruction to end formatting. Set SO18 shows a code ([BS]) of the key operated for moving a cursor key depending on the number of digits of the fractional part. When the number of digits of the fractional part is nine digits or less, two key codes ([BS] [BS]) are provided. When the number of digits thereof is 10 digits or more, three key codes ([BS] [BS] [BS]) are provided.

When the running program of PC 100 is table generator 202, table generator 202 performs a process based on the received codes of sets SO12 to SO18. Specifically, based on the codes of sets SO12 and SO13, table generator 202 causes a font tab for setting the font to be opened and displayed in a formatting dialog on display 107. Then, based on the codes of set SO14, table generator 202 changes the displayed tab from the font tab to a display format tab for formatting display. Subsequently, based on the codes of sets SO15 and SO16, table generator 202 sets the number of digits of the fractional part to “4” by the display format tab. After this, based on the code of set SO17, table generator 202 stores in main storage unit 103 the data “currency style separated with digit separators” including the number of digits of the fractional part, and closes (erases) the formatting dialog of display 107. At this time, the Excel screen of display 107 returns to the original screen (Excel screen of set SO12).

Accordingly, the process of changing the format to “currency style separated with digit separators” by table generator 202 is completed. After this, in the case where table generator 202 receives from calculator 400 a character code string representing an integer or numerical values having a fractional part of 12 digits or more, table generator 202 performs a display process in accordance with the format data “currency style separated with digit separators” in main storage unit 103.

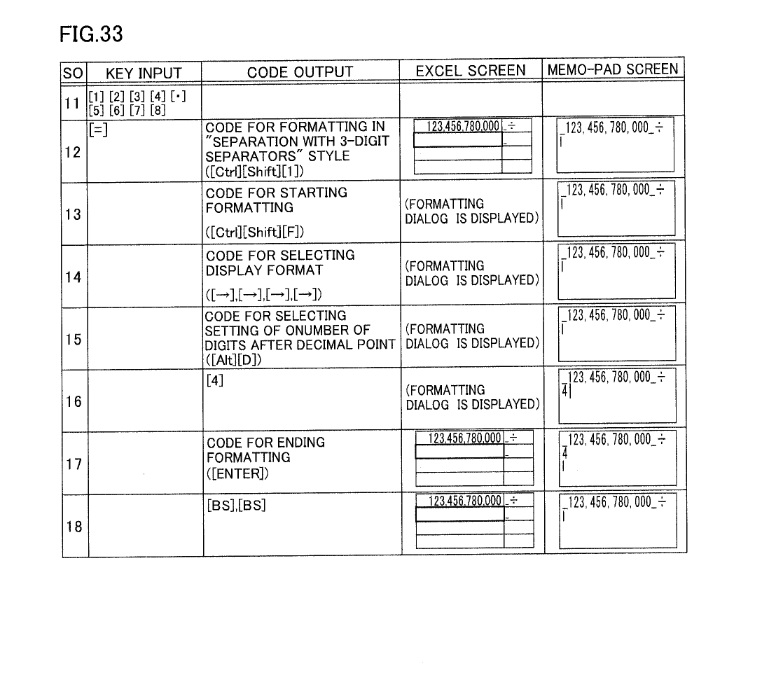

In contrast, in the case where the running program is text editor 201, the codes of sets SO12 to SO15 for text editor 201 among the codes of sets SO12 to SO18 in FIG. 33 are invalid. Therefore, even when the codes of sets SO12 to SO15 are received, the memo-pad screen of display 107 is not changed. Then, text editor 201 follows the codes of sets SO16 and SO17 to display “4” on the memo-pad screen and thereafter moves the cursor which is located after “4” to the next row (see the memo-pad screens of sets SO16 and SO17 in FIG. 33). After this, receiving the codes of set SO18, text editor 201 moves the cursor backward in accordance with the received codes ([BS] [BS]). Accordingly “4” is deleted from the memo-pad screen and the cursor is moved back to the original position (see the memo-pad screen of set SO18 in FIG. 33).

After the above-described formatting codes for table generator 202 are transmitted, the code string of “1234.5678” and “=” which are input in sets SO11 and SO12 is generated similarly to the above-described sets SP11 to SP17 and transmitted to PC 100 (see sets SO19 to SO25).

Subsequently, generation unit 410 generates the shortcut key code ([Ctrl] [Shift] [1]) for formatting Excel in “separation with 3-digit separators” style (currency style) (set SO26). The generated shortcut key code is transmitted to PC 100. When the running program of PC 100 is table generator 202, table generator 202 changes the format style to “currency style separated with digit separators” in accordance with the received shortcut key code. When the running program is text editor 201, the shortcut key code is invalid.

After this, similarly to the above-described sets SP18 to SP24, the control-codes-mixed information including a code string of “100000000” which is the result of the arithmetic operation and “*” is generated (sets SO27 to SO33). The generated control-codes-mixed information is transmitted to PC 100. PC 100 displays, based on the received control-codes-mixed information, the numerical values and operators so that the arrangement of them in each row on the Excel screen and that on the memo-pad screen are matched to each other (see set SO33).

### Process Flow

Referring to FIGS. 23, 36, and 37, generation of the control-codes-mixed information described above with reference to FIGS. 32 to 35 and transmission of the information to PC 100 will be described. The flowcharts of FIGS. 23, 36, and 37 have been stored as programs in storage unit 402 in advance. CPU 401 reads the programs from storage unit 402 and executes the read programs.

The flowchart of FIG. 23 is also applicable to the fifth embodiment. In the fifth embodiment, while the step of “Process SUB2” included in the steps of FIG. 23 differs from other embodiments, the other steps are similar to the other embodiments. Therefore, the description of them will not be repeated.

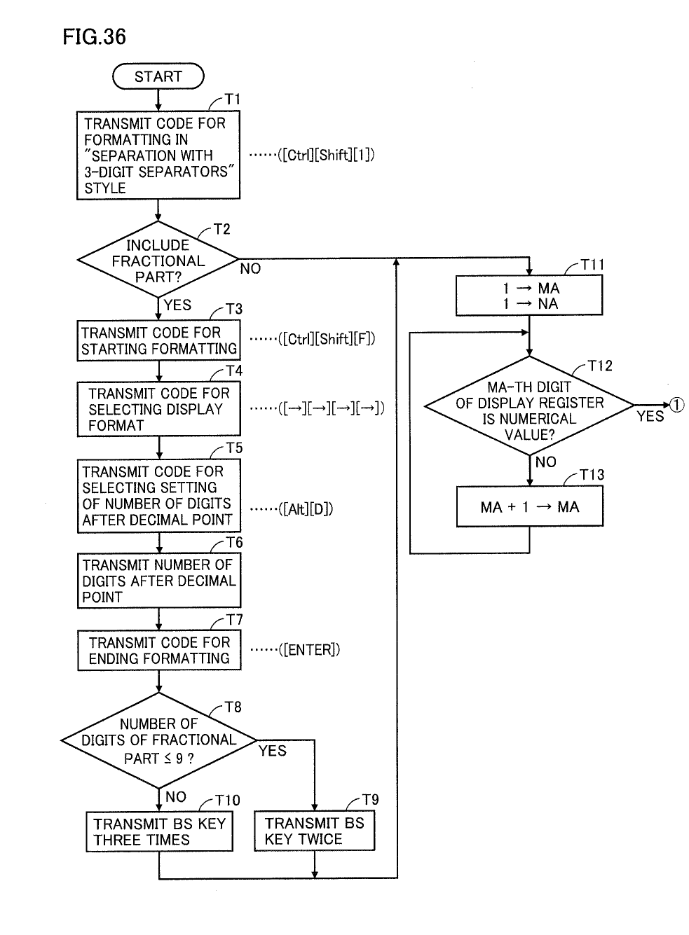

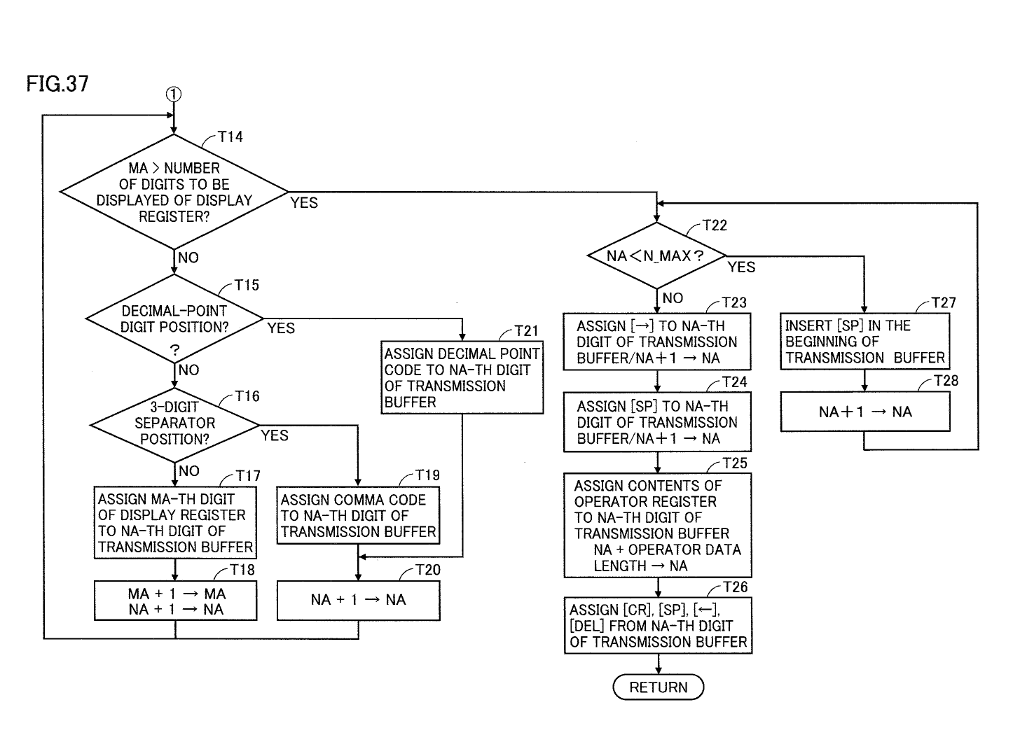

“Process SUB2” in the fifth embodiment is shown in FIGS. 36 and 37. Referring to FIG. 36, generation unit 410 first generates the code ([Ctrl] [Shift] [1]) for formatting table generator 202 in “separation with 3-digit separators” style (step T1). The generated code is transmitted to PC 100. The generation and transmission of the code corresponds to the above-described sets SO3, SO12, and SO26.

After this, generation unit 410 determines whether or not the character code string in display register 503 includes a fractional part (step T2). When generation unit 410 determines that it includes a fractional part (YES in step T2), the process of steps T3 to T10 is performed.

In steps T3 to T10, the codes for formatting table generator 202 shown in the above-described sets SO13 to SO18 are generated, and the generated codes are transmitted to PC 100. In FIG. 36, the codes (including the shortcut key code) generated in steps T3 to T10 are shown in association with these steps, for the sake of description.

In contrast, when it is determined that the character code string in display register 503 does not include a fractional part (NO in step T2), namely when the character code string of set SO2 or set SO27 is stored in display register 503, the process of steps T11 to T13 is performed similarly to the above-described steps T30 to T32. In steps T11 to T13, initial values are set to variables MA and NA, and the ordinal position of the digit with respect to the beginning of display register 503, from which a character code string of numerical values in display register 503 starts, is detected. The detected ordinal position of the digit with respect to the beginning thereof is represented by the value of variable MA.

Referring to FIG. 37, generation unit 410 determines whether or not a conditional expression (MA>the number of digits to be displayed of display register 503) is met (step T14). In the present embodiment, the number of digits to be displayed in this conditional expression is 16 digits.

When it is determined that the condition is not met (NO in step T14), generation unit 410 determines whether or not the value of variable MA represents the decimal-point digit position (the number of digits calculated in steps S29a, S29b, S12a, S17a) (step T15).

When it is determined that the value of variable MA represents the decimal-point digit position (YES in step T15), generation unit 410 stores the decimal point code in the NA-th digit of transmission buffer 504 (step T21). After this, the process flow proceeds to step T20 described later herein.

In contract, when it is determined that the value of variable MA does not represent the decimal-point digit position (NO in step T15), the process of steps T16 to T20 is performed similarly to the above-described steps T35 to T39. In steps T16 to T20, the character code string in display register 503 in which the character code(s) of comma is inserted for every three digits is stored in transmission buffer 504.

In step T14 again, when it is determined that the condition is met (YES in step T14), the process flow proceeds to steps T22 to T28. In steps T22 to T28, the process of the above-described steps T46 to T52 is performed similarly. Accordingly, the control-codes-mixed information of sets SO4 to SO10, or SO19 to SO25, or SO27 to SO33 is generated, and the generated control-codes-mixed information is stored in transmission buffer 504.

In the fifth embodiment, the formatting codes (including the shortcut key code) for table generator 202 are transmitted to PC 100 as shown in steps T1 to T10. As shown in sets SO12 to SO18, the codes are used for controlling the format and display so that what is displayed on the Excel screen by table generator 202 is identical to those of the first to fourth embodiments. The formatting codes do not change at all what is displayed on the memo-pad screen by text editor 201. Therefore, regardless of whether the running program of PC 100 is text editor 201 or table generator 202, the Excel screen and the memo-pad screen can be made identical to each other in terms of the arrangement of a character string (such as the number of digits and where they are displayed) displayed on display 107.

### Sixth Embodiment

Although each of the above-described embodiments generates the control-codes-mixed information in which the character codes of numerical values and operator and the control codes are arranged in accordance with a predetermined rule as shown in FIGS. 9 to 11 and FIGS. 15 to 17, the applied rule is not limited to this.

The space codes [SP] in the code outputs such as those of sets SN3, SN11, SN18, SM3, SM9, SM14 are added for adjusting the digits to be displayed by text editor 201. Specifically, the space codes [SP] are added depending on the number of digits of numerical values, so that the rows are identical to each other in terms of the total number determined by (the number of space codes [SP])+(the number of digits of numerical values). The total number is not less than the value of the lower limit of the number of digits depending on the specification of calculator 400. While the number of digits is 12 or 16 in each embodiment, the number of digits is not limited as long as the number of digits does not deteriorate the visibility of the screen displayed on display 107.

The space code [SP] placed before the operator like those of sets SN5, SN13, SN20, SM6, SM12 and SM17 serves to keep a distance (space) between the numerical value and the operator and ensure the visibility. While each embodiment places one space code [SP], the number of space codes is not limited to one and may be zero for example.

### Seventh Embodiment

In the first and second embodiments for example, one or more sets of character codes made up of numerical values and operators entered through user's operation of keyboard 405 are received and, each time reception unit 411 receives the set, generation unit 410 generates control-codes-mixed information (see FIGS. 7 and 14) made up of the character codes of numerical value and operator of the set as well as control codes and transmits the generated control-codes-mixed information to PC 100. How to transmit the control-codes-mixed information, however, is not limited to this. The numerical value in “character codes made up of numerical value and operator” may be null. “Operator” includes not only the operators for the four arithmetic operations and operators corresponding to common operator keys, but also a key operated to require an arithmetic operation to be performed, namely operators corresponding to keys for calculating the sum and calculating the tax.

For example, generation unit 410 stores the generated control-codes-mixed information of each set in a file of storage unit 402 and transmits the information when storage thereof in the file is completed. For example, in response to a user's transmission command through operation of transmission key 604, CPU 401 may read the file from storage unit 402 and transfer the file through information transmission unit 412 to PC 100.

### Eighth Embodiment

The program which follows each flowchart of the embodiments as described above has been stored in advance in storage unit 402, and CPU 401 reads the program from storage unit 402 and executes it. Such a program may also be recorded on a non-transitory recording medium readable by CPU 401 and provided in the form of a program product like external storage unit 408 provided as an accessory of calculator 400. Alternatively, the program may also be provided by being received through a network (not shown) and via communication unit 403 and then downloaded into a storage area of storage unit 402.

The provided program product includes the program itself and the recording medium on which the program is recorded.

### Effects of the Embodiments

Arithmetic information (control-codes-mixed information) having a plurality of codes which include numerical values and operators received by an arithmetic processing device (calculator 400) is transmitted to an external device (PC 100), and the external device displays on a display unit (display 107) a plurality of rows including the numerical values and operators in accordance with the arithmetic information. A generation unit (generation unit 410) of the arithmetic processing device generates the arithmetic information in which the codes are arranged so that an arrangement of numerical values and operator in each row and an arrangement of numerical values and operator in another row displayed on the display unit are matched to each other.

In the case where the aforementioned row including numerical values and operator is output to a print unit of the arithmetic processing device and to the display unit of the external device, it can be printed and displayed in accordance with the arithmetic information so that the arrangement of the numerical values and operator in the printed row is matched to the arrangement of the numerical values and operator in the displayed row.

Even when one of different programs is executed in the external device, these programs can be matched to each other in terms of the arrangement of numerical values and operator in a displayed row.

Conventionally, a PC on which table generator 202 such as Excel is not installed cannot display the printed contents of printer 406 that are received from calculator 400. If, in order to overcome this, the printed contents to be transmitted from calculator 400 are generated in a format adapted solely to text editor 201, the printed contents may be difficult to be displayed or processed by spreadsheet software such as Excel. Although dedicated application software may be developed to facilitate display, storage, and processing of printed contents, it requires a large development cost, resulting in an increase of the cost of calculator 400.

In the above-described embodiments, control-codes-mixed information is generated for displaying, on PC 100, based on the printed contents of printer 406 of calculator 400. Text editor 201 which is standard software installed on the PC and table generator 202 such as spreadsheet software with which subsequent data processing is facilitated each display information in accordance with the control-codes-mixed information. Therefore, the PC can match, without requiring dedicated application software, the contents displayed by the PC to the contents printed by printer 406.

Accordingly, even if spreadsheet software is not installed on the PC, the PC can display the information by means of standard text editor 201 and can also display the information by means of table generator 202 such as spreadsheet software which facilitates re-processing of data. In this way, the problem of the increase in cost can be overcome.

### Features of the Embodiments

In each embodiment, an arithmetic processing device (calculator 400) capable of communicating with an external device (PC 100) including a display unit (display 107) includes: a reception unit (411) for receiving information including a numerical value and an operator; a generation unit (410) generating arithmetic information (control-codes-mixed information) regarding an arithmetic operation and having a plurality of codes including the numerical value and the operator received by the reception unit; and an information transmission unit (412) transmitting the generated arithmetic information to the external device. The generation unit generates the arithmetic information in which the codes are arranged so that, when a plurality of rows including numerical values and operators are displayed on the display unit in accordance with the arithmetic information, an arrangement of a numerical value and an operator in each displayed row and an arrangement of a numerical value and an operator in another displayed row are matched to each other.

Thus, in the case where information made up of numerical values and operators received by the arithmetic processing device is transmitted to the external device and displayed on its display unit, the external device can display them so that different rows are matched to each other in terms of the arrangement of a numerical value and an operator.

The arithmetic information includes a control code for displaying the rows so that the arrangement of a numerical value and an operator in each row and the arrangement of a numerical value and an operator in another row are matched to each other, and the plurality of codes of the arithmetic information are arranged in accordance with a predetermined rule. Thus, the arithmetic information is generated by means of the control code and the rule.

The numerical value includes an integer of at least three consecutive digits and the plurality of codes include a separator code for displaying the integer with every three digits separated by the separator. Thus, the integer in each row is displayed with every three digits separated.

The generation unit generates the arithmetic information each time the reception unit receives the operator, and the information transmission unit further transmits the arithmetic information to the external device each time the arithmetic information is generated. Thus, each time the operator is received, the arithmetic information generated accordingly is transmitted to the external device.

The external device is capable of running a program, and the program displays the numerical value and the operator on the display unit in accordance with the arithmetic information. The program includes a program (text editor 201) for displaying information in a document format or a program (table generator 202) for displaying information in a table format. While the external device may run different programs, it can match the programs to each other in terms of the arrangement of a numerical value and an operator in each displayed row.

The plurality of codes included in the arithmetic information include a code for specifying setting information regarding display by the program. The arithmetic processing device transmits the arithmetic information to the external device to thereby specify, for the external device, the setting information regarding display by the program.

The arithmetic information includes, for a set of one or more numerical values and an associated operator that are received by the reception unit, a code string made up of a numeric code string of the one or more numerical values, a code of the associated operator, and control codes different in type from each other. The different control codes include a space code, a tab code, a backspace code, and a newline code for controlling the position where a cursor is displayed. The aforementioned predetermined rule refers to a rule following which the numeric code string, the tab code, the backspace code, the space code, the code of the operator, and the newline code are arranged in this order in the code string and one or more space codes are added to the numeric code string so that the numeric code string satisfies a predetermined number of digits to be displayed. Thus, in accordance with the predetermined rule, a plurality of codes such as numeric code, operator code, and control codes are arranged to thereby generate the code string for the arithmetic information.

The arithmetic processing device further includes a print unit (printer 406) for printing information. The print unit prints the numerical value and the operator received by the reception unit so that an arrangement of the numerical value and the operator and an arrangement of the numerical value and the operator displayed on the display unit by the external device are matched to each other.

Thus, an arrangement of the numerical value and the operator printed by the print unit of the arithmetic processing device and an arrangement of the numerical value and the operator displayed on the display unit of the external device can be matched to each other.

In the case where the above-described arithmetic processing device is applied to calculator 400, information based on an arrangement of numerical value and operator received through user's operation of keyboard 405 for example of calculator 400 can be displayed on the external device instead of or in addition to being displayed on the calculator.

Although the present invention has been described and illustrated in detail, it is clearly understood that the same is by way of illustration and example only and is not to be taken by way of limitation, the scope of the present invention being interpreted by the terms of the appended claims.

1. An arithmetic processing device capable of communicating with an external device including a display unit, said arithmetic processing device comprising:
a reception unit configured to receive information including a numerical value and an operator;
a generation unit configured to generate arithmetic information regarding an arithmetic operation and having a plurality of codes including the numerical value and the operator received by said reception unit; and
an information transmission configured to transmit said generated arithmetic information to said external device,
said generation unit being configured to generate the arithmetic information in which the codes are arranged so that, when a plurality of rows including numerical values and operators are displayed on said display unit in accordance with said arithmetic information, an arrangement of a numerical value and an operator in each displayed row and an arrangement of a numerical value and an operator in another displayed row are matched to each other.

2. The arithmetic processing device according to claim 1, wherein
said arithmetic information includes a control code for displaying the rows so that an arrangement of a numerical value and an operator in said each row and an arrangement of a numerical value and an operator in said another row are matched to each other, and
said plurality of codes of said arithmetic information are arranged in accordance with a predetermined rule.

3. The arithmetic processing device according to claim 2, wherein said numerical value includes an integer of at least three consecutive digits and said plurality of codes include a separator code for displaying said integer with every three digits separated by the separator.

4. The arithmetic processing device according to claim 1, wherein
said generation unit is further configured to generate said arithmetic information each time said reception unit receives said operator, and
said information transmission unit is further configured to transmit said arithmetic information to said external device each time said arithmetic information is generated.

5. The arithmetic processing device according to claim 1, wherein
said external device is capable of running a program, and
said program displays said numerical value and said operator on said display unit in accordance with said arithmetic information.

6. The arithmetic processing device according to claim 5, wherein said program includes a program for displaying information in a document format or a program for displaying information in a table format.

7. The arithmetic processing device according to claim 6, wherein said plurality of codes include a code for specifying setting information regarding display by said program.

8. The arithmetic processing device according to claim 1, further comprising a print unit configured to print information, wherein
said print unit configured to print the numerical value and the operator received by said reception unit so that an arrangement of the numerical value and the operator and an arrangement of the numerical value and the operator displayed on said display unit by said external device are matched to each other.

9. An arithmetic processing method comprising:
communicating with an external device including a display unit;
receiving information including a numerical value and an operator;
generating arithmetic information regarding an arithmetic operation and having a plurality of codes including the numerical value and the operator that are received; and
transmitting said generated arithmetic information to said external device,
said generating step generating the arithmetic information in which the codes are arranged so that, when a plurality of rows including numerical values and operators are displayed on said display unit in accordance with said arithmetic information, an arrangement of a numerical value and an operator in each displayed row and an arrangement of a numerical value and an operator in another displayed row are matched to each other.

10. A non-transitory computer readable recording medium storing a program causing a computer including a processor to execute an arithmetic processing method, said program causing said processor to execute:
communicating with an external device including a display unit;
receiving information including a numerical value and an operator;
generating arithmetic information regarding an arithmetic operation and having a plurality of codes including the numerical value and the operator that are received; and
transmitting said generated arithmetic information to said external device,
said generating step generating the arithmetic information in which the codes are arranged so that, when a plurality of rows including numerical values and operators are displayed on said display unit in accordance with said arithmetic information, an arrangement of a numerical value and an operator in each displayed row and an arrangement of a numerical value and an operator in another displayed row are matched to each other.

11. (canceled)

12. The arithmetic processing method according to claim 9, wherein
said arithmetic information includes a control code for displaying the rows so that an arrangement of a numerical value and an operator in said each row and an arrangement of a numerical value and an operator in said another row are matched to each other, and
said plurality of codes of said arithmetic information are arranged in accordance with a predetermined rule.

13. The arithmetic processing method according to claim 12, wherein said numerical value includes an integer of at least three consecutive digits and said plurality of codes include a separator code for displaying said integer with every three digits separated by the separator.

14. The arithmetic processing method according to claim 9, wherein
said generating includes generating said arithmetic information each time said reception unit receives said operator, and
said transmitting includes transmitting said arithmetic information to said external device each time said arithmetic information is generated.

15. The arithmetic processing method according to claim 9, wherein
said external device is capable of running a program, and
said program displays said numerical value and said operator on said display unit in accordance with said arithmetic information.

16. The arithmetic processing method according to claim 15, wherein said program includes a program for displaying information in a document format or a program for displaying information in a table format.

17. The arithmetic processing method according to claim 16, wherein said plurality of codes include a code for specifying setting information regarding display by said program.

18. The arithmetic processing method according to claim 9, further comprising printing the numerical value and the operator received by said receiving so that an arrangement of the numerical value and the operator and an arrangement of the numerical value and the operator displayed on said display unit by said external device are matched to each other.
